(19) United States
(12) Patent Application Publication
(10) Pub. No.: US 2023/0083772 A1
(43) Pub. Date: Mar. 16, 2023

(54) BI-FOLD DOOR

(71) Applicant: Harper Engineering Co., Renton, WA (US)

(72) Inventor: David Chadwell, Renton, WA (US)

(21) Appl. No.: 17/939,761

(22) Filed: Sep. 7, 2022

Related U.S. Application Data
(60) Provisional application No. 63/243,006, filed on Sep. 10, 2021.

(51) Int. Cl. B64C 1/14; E05D 15/26; E05B 53/00

(52) U.S. Cl. CPC B64C 1/1461; E05D 15/264; E05B 53/001

(57) ABSTRACT

The present disclosure is directed to a bi-fold door system, apparatus, or device including a first panel, a second panel, and a center post. When in a fully closed position, the bi-fold door limits access to a lavatory on an aircraft, and, alternatively, when in a fully opened position, the bi-fold door allows or provides access to the lavatory on the aircraft. When in the closed position, a user within the lavatory may lock the bi-fold door in the closed position by stepping on a foot pedal at an interior of the bi-fold door. The foot pedal mechanically cooperates with a lock rod and an escapement mechanism the user stepping on the foot pedal moves the lock rod from a retracted position to an extended position locking the bi-fold door in the closed position. To exit the lavatory, the user may unlock the bi-fold door utilizing the foot pedal and then interact with a hands-free actuation mechanism to move the bi-fold door from the closed position to the opened position. When in the opened position, the bi-fold door may be held open for a selected period of time such that the user may exit the lavatory without physically contacting the bi-fold door.

### CROSS-REFERENCE TO RELATED APPLICATION

The present application claims the benefit of U.S. Provisional Patent Application No. 63/243,006, filed Sep. 10, 2021, which is entirely incorporated by reference herein.

### BACKGROUND

### Technical Field

The present disclosure is directed to at least one foldable door for use, for example, to limit and provide access to a lavatory on an aircraft.

### Description of the Related Art

Aircrafts can be segregated or separated into a flight deck, a passenger deck, and lavatories, among other regions/sections. Access to the lavatory may be limited by a bi-fold door that provides ingress and egress for passengers, flight crew members, pilots or other individuals that may desire to access the lavatory (e.g., bathroom) when having to go to the bathroom (e.g., defecating and/or urinating). The bi-fold door may be lockable to limit ingress into the lavatory to avoid interruption while the user is going to the bathroom (e.g., defecating and/or urinating).

Generally, a conventional bi-fold door may be moved by a user utilizing a hand to move the conventional bi-fold door between an opened position (e.g., folded position) and a closed position (e.g., expanded position) to enter and exit the lavatory, respectively. When the user is entering the lavatory, the user pulls and/or pushes on a first handle accessible at an exterior of the bi-fold door or on the exterior itself to enter the lavatory. Pulling and/or pushing on the first handle or the exterior moves the bi-fold door from the closed position to the opened position in which the bi-fold door is folded. After the user enters the lavatory, the user pulls and/or pushes on a second handle accessible at an interior or on the interior itself of the bi-fold door to move the bi-fold door from the opened position to the closed position in which the bi-fold door is expanded. The user then actuates a lock with their hand locking the bi-fold door such that another individual (e.g., passenger, flight crew member, pilot, etc.) may not enter the lavatory through the bi-fold door to avoid interruption of the user as the user goes to the bathroom (e.g., defecating and/or urinating). After the user has finished going to the bathroom, the user unlocks the lock with their hand unlocking the bi-fold door. Then the user pulls and/or pushes on the second handle or the interior of the bi-fold door moving the bi-fold door from the closed position to the opened position such that the user may readily exit the lavatory.

Generally, a conventional bi-fold door may include at least one torsional spring that is biased towards the closed position. For example, when the user releases the bi-fold door when in the opened position, the torsional spring applies a torque to the bi-fold door such that the bi-fold door at least begins to move from the opened position (e.g., folded position) to the closed position (e.g., expanded position). Generally, the at least one torsional spring only applies enough torque to only partially move the bi-fold door from the opened position towards the closed position.

Generally, a conventional bi-fold door is fixedly mounted to a jamb of a frame such that the conventional bi-fold door is held stationary relative to the jamb of the frame. This may result in the bi-fold door binding such that the bi-fold door may not easily or readily be moved from the opened position to the closed position or vice versa. For example, when the aircraft with the conventional bi-fold door is underway (e.g., flying), the aircraft may be exposed to turbulence which may result in the bi-fold door slightly displaced such that the door is slightly out of place or misaligned with tracks of which the conventional bi-fold door is in mechanical cooperation. This slight misalignment of the bi-fold door may result in the bi-fold door binding with the tracks such that a user may not readily be able to apply enough force to the bi-fold door to open the bi-fold door. Alternatively, the user may be able to apply enough force to overcome the binding of the bi-fold door, however, this may result in damaging or reducing the life span of the bi-fold door such that the bi-fold door may need to be replaced more quickly than expected or desired resulting in more frequent maintenance, replacement costs, or both.

### BRIEF SUMMARY

The present disclosure is directed to a bi-fold door that may be moved from the closed position to the opened position without a user utilizing a hand (e.g., hands-free operation) to open the bi-fold door of the present disclosure. In other words, the bi-fold door may be opened without the user utilizing their hands to open the bi-fold door after washing their hands to provide a more sanitary and hygienic experience when going to the lavatory on the aircraft. Generally, lavatories on aircraft become relatively unhygienic and unsanitary due to multiple uses by multiple individuals, which may at least be partially due to unexpected movements of the aircraft when an individual is utilizing the lavatory while the aircraft is underway (e.g., flying).

The present disclosure is directed to at least one embodiment including a bi-fold door system including a header and a bi-fold door in mechanical cooperation with the header. The bi-fold door includes an opened position and a closed position. An exterior surface of the bi-fold door is opposite to an interior surface of the bi-fold door. A top end of the bi-fold door is opposite to a bottom end of the bi-fold door. A first panel of the bi-fold door extends from the top end to the bottom end. A second panel of the bi-fold door is in mechanical cooperation with the first panel, and the second panel extends from the top end to the bottom end. A center post of the bi-fold door is between the first panel and the second panel, and the center post mechanically couples the first panel to the second panel. A lock rod includes an extended position and a retracted position. When in the extended position, the lock rod extends into an opening of the header and locks the bi-fold door in locked state (e.g., holds the bi-fold door in a locked position) when in a closed position. When the lock rod is in the retracted position, the bi-fold door is in an unlocked state such that the bi-fold door may be moved from a closed position to an open position. In other words, the bi-fold door may be opened. A lock pedal is in mechanical cooperation with the lock rod and is accessible at the interior surface of the first panel. The lock pedal is closer to the bottom end than the top end of the bi-fold door, and the lock pedal is configured to actuate the lock rod between the extended position and the retracted position to unlock and lock the bi-fold door by a user present within a lavatory of an aircraft.

### BRIEF DESCRIPTION OF THE SEVERAL VIEWS OF THE DRAWINGS

For a better understanding of the embodiments, reference will now be made by way of example to the accompanying drawings. In the drawings, identical reference numbers identify the same or similar elements or acts unless the context indicates otherwise. The sizes and relative proportions of the elements in the drawings are not necessarily drawn to scale. For example, some of these elements may be enlarged and positioned to improve drawing legibility.

FIG. 1A is a perspective view of an embodiment of a bi-fold door of the present disclosure;

FIG. 1B is a front view of the embodiment of the bi-fold door as shown in FIG. 1A;

FIG. 1C is a rear view of the embodiment of the bi-fold door as shown in FIGS. 1A and 1B;

FIG. 1D is a left-side view of the embodiment of the bi-fold door as shown in FIGS. 1A-1C;

FIG. 1E is a right-side view of the embodiment of the bi-fold door as shown in FIGS. 1A-1D;

FIG. 2A is an enlarged, partial view of a front section at a top end of the embodiment of the bi-fold door as shown in FIGS. 1A-1E;

FIG. 2B is an enlarged, partial view of a rear section at a top end of the embodiment of the bi-fold door as shown in FIGS. 1A-1E;

FIG. 2C is an enlarged, partial view of a left-hand side section at a top end of the embodiment of the bi-fold door as shown in FIGS. 1A-1E;

FIG. 2D is an enlarged, partial view of a right-hand side section at a top end of the embodiment of the bi-fold door as shown in FIGS. 1A-1E;

FIG. 2E is an enlarged, partial front sectional view at the top end of the embodiment of the bi-fold door as shown in FIGS. 1A-1E;

FIG. 2F is an enlarged, partial rear sectional view at the top end of the embodiment of the bi-fold door as shown in FIGS. 1A-1E;

FIG. 3A is an enlarged, partial view of a rear section at a bottom end of the embodiment of the bi-fold door as shown in FIGS. 1A-1E;

FIG. 3B is an enlarged, partial rear sectional view at the bottom end of the embodiment of the bi-fold door as shown in FIGS. 1A-1E;

FIG. 3C is an enlarged, partial view of a section 3C of the rear sectional view at the bottom end of the embodiment of the bi-fold door as shown in FIG. 3B;

FIG. 3D is an enlarged, partial view of a bottom end of the embodiment of the bi-fold door as shown in FIGS. 1A-1E;

FIG. 4A is an enlarged view of an escapement of the embodiment of the bi-fold door as shown in FIGS. 1A-1E;

FIG. 4B is an enlarged view of the escapement of the embodiment of the bi-fold door as shown in FIGS. 1A-1E;

FIG. 4C is an enlarged, partial rear sectional view at the top end of the embodiment of the bi-fold door as shown in FIGS. 1A-1E;

FIG. 4D is an enlarged, partial view of a section of the enlarged, partial sectional view at the top end of the embodiment of the bi-fold door as shown in FIG. 4C;

FIG. 4E is an enlarged view of a track of the escapement as shown in FIGS. 4A-4D;

FIG. 4F is an enlarged view of a lock indication mechanism when the embodiment of the bi-fold door as shown in FIGS. 1A-1E is locked;

FIG. 4G is an enlarged view of the lock indication mechanism when the embodiment of the bi-fold door as shown in FIGS. 1A-1E is unlocked;

FIG. 5A is a top view of the embodiment of the bi-fold door as shown in FIGS. 1A-1E in an opened position (e.g., folded position);

FIG. 5B is an enlarged, partial view of the top end of the embodiment of the bi-fold door as shown in FIGS. 1A-1E in the opened position (e.g., folded position); and

FIG. 6 is an enlarged, partial view of the top end of the embodiment of the bi-fold door as shown in FIGS. 1A-1E when a first panel is slight offset relative to a second panel of the embodiment of the bi-fold door.

### DETAILED DESCRIPTION

In the following description, certain specific details are set forth in order to provide a thorough understanding of various embodiments of the disclosure. However, one skilled in the art will understand that the disclosure may be practiced without these specific details. In other instances, well-known structures associated with bi-fold doors or other similar foldable doors have not been described in detail to avoid unnecessarily obscuring the descriptions of the embodiments of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.” The use of ordinals such as first, second, third, etc., does not necessarily imply a ranked sense of order, but rather may only distinguish between multiple instances of an act or a similar structure or material.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terms “top,” “bottom,” “upper,” “lower,” “left,” and “right,” are used for only discussion purposes based on the orientation of the components in the discussion of the Figures in the present disclosure as follows. These terms are not limiting as the possible positions explicitly disclosed, implicitly disclosed, or inherently disclosed in the present disclosure.

The term “substantially” is used to clarify that there may be slight differences and variation when a bi-fold door is manufactured in the real world, as nothing can be made perfectly equal or perfectly the same. In other words, “substantially” means and represents that there may be some slight variation in actual practice and instead is made or manufactured within selected tolerances or may be within selected tolerances.

As used in this specification and the appended claims, the singular forms “a,” “an,” and “the” include plural referents unless the content clearly dictates otherwise.

While one embodiment is shown and described with respect to bi-fold doors, it will be readily appreciated that embodiments of the present disclosure are not limited thereto. In various embodiments, the structures, devices, methods and the like described herein may be embodied in or otherwise utilized in any suitable types of bi-fold doors or similar foldable doors for entering (e.g., ingress) and exiting (e.g., egress) a lavatory of an aircraft.

The present disclosure is directed to at least one embodiment of a bi-fold door improving a user's ease of use as well as improving the user's hygienic and sanitary experience when utilizing the bi-fold door to enter and exit the lavatory. The user's ease of use may be improved as the at least one embodiment of the bi-fold door may have a reduced likelihood of the bi-fold door binding up (e.g., be jammed in place, wedged in place, or some other type of obstruction) hindering the user's capability of moving the bi-fold door from a closed position (e.g., expanded position) to an opened position (e.g., foldable position) or vice versa. The user's hygienic and sanitary experience may be improved as the at least one embodiment of the bi-fold door may be moved from the closed position to the opened position by a hands-free operation such that the user may not touch the at least one embodiment of the bi-fold door with their hands when exiting the lavatory through the at least one embodiment of the bi-fold door. In other words, after the user washes their hands, the user may exit the lavatory without having to physically touch the at least one embodiment of the bi-fold door after washing their hands reducing the user's exposure to germs or pathogens that may be present on the at least one embodiment of the bi-fold door.

The present disclosure is directed to a bi-fold door (e.g., foldable door) including a closed position in which the bi-fold door is expanded (e.g., unfolded) blocking off or limiting access to a lavatory of an aircraft, and an opened position in which the bi-fold door is folded providing entry and access to the lavatory of the aircraft through the bi-fold door. For example, when a user enters the lavatory through the bi-fold door, the user moves the bi-fold door from the closed position to the opened position to access the lavatory. After entering the lavatory through the bi-fold door, the user then moves the bi-fold door from the opened position to the closed position and locks the bi-fold door in the closed position by actuating a foot pedal at an internal surface of the bi-fold door in mechanical cooperation with a locking mechanism (e.g., lock rod). Actuating the foot pedal actuates the locking mechanism from an unlocked state to a locked state to limit access by other individuals to the lavatory when the user is present within the lavatory and is going to the bathroom (e.g., defecating and/or urinating). The foot pedal present at the internal surface of the bi-fold door is closer to a bottom end of the bi-fold door than a top end of the bi-fold door such that the user may readily and easily actuate the foot pedal by stepping and pushing downward on the foot pedal with their foot (e.g., depressing the foot pedal with their foot).

After going to the bathroom (e.g., defecating and/or urinating), the user may wash their hands in a sink present within the lavatory. The user may then unlock the door by stepping and pushing downward on the foot pedal with their foot actuating the locking mechanism from the locked state to the unlocked state such that the bi-fold door is readily moveable from the closed position to the opened position. An automatic opening mechanism (e.g., mechanical or electrical) may be in mechanical cooperation or electrical communication with a hands-free actuation mechanism (e.g., another foot pedal, an object sensor such as a time-of-flight sensor (TOF), or some other type of hands-free actuation mechanism either in mechanical cooperation or electrical communication with the automated opening mechanism) accessible within the lavatory. After unlocking the bi-fold door, the user interacts with the hands-free actuation mechanism resulting in the automated opening mechanism may automatically move the bi-fold door from the closed position to the opened position such that the user does not touch a surface within the lavatory after washing their hands.

Once the bi-fold door is in the opened position, the user exits the lavatory. The bi-fold door is temporarily held in the opened position for a selected period of time by a delay mechanism that delays the bi-fold door from moving from the opened position towards the closed position. This delay in closure of the bi-fold door by being held in the opened position provides the user enough time to exit the lavatory without having to physically touch or contact the bi-fold door after washing their hands in the sink within the lavatory. This hands-free operation after the user washes their hands improves the hygienic and sanitary experience when the user utilizes the lavatory of the aircraft to go to the bathroom (e.g., defecating and/or urinating).

After the selected period of time has passed, a torsional spring within the bi-fold door biased towards the closed position applies a torque to the bi-fold door moving the bi-fold door away from the opened position towards the closed position. To move the bi-fold door to the fully opened position, a user applies enough force to the bi-fold door to overcome the torque of the torsional spring biased towards the closed position.

The torsional spring may apply enough torque to the bi-fold door to move the bi-fold door from the opened position entirely to the fully closed position without any assistance by the user. A rotary dampener may be in mechanical cooperation with the bi-fold door such that the bi-fold door does not slam into the closed position to reduce the likelihood of a hand of an individual being injured (e.g., slammed, crushed, etc.) by the bi-fold door moving from the opened position to the closed position by the torque of the torsional spring. The torque applied by the torsional spring to the bi-fold door may be adjusted and customized to increase or reduce the speed at which the bi-fold door is moved from the opened position towards the closed position.

A plurality of spherical hinges (e.g., spherical joints) may couple the bi-fold door to a door frame (e.g., jambs, header, etc.) such that the bi-fold door may have degrees-of-freedom (e.g., rotational degrees-of-freedom) to accommodate deflection of the bi-fold door while the aircraft is underway (e.g., flying). A plurality of ball bearings may be present along a center post that mechanically couples a first panel of the bi-fold door to a second panel of the bi-fold door. The plurality of ball bearings along the center post are free to translate vertically while also being free to rotate to accommodate the deflection of the bi-fold door while the aircraft is underway (e.g., flying). The plurality of spherical hinges and the plurality of ball bearings reduce the likelihood of the bi-fold door (e.g., the first panel and/or the second panel) binding up (e.g., being jammed, being stuck, etc.) such that the bi-fold door may not be readily or easily moved from the opened position to the closed position or vice versa.

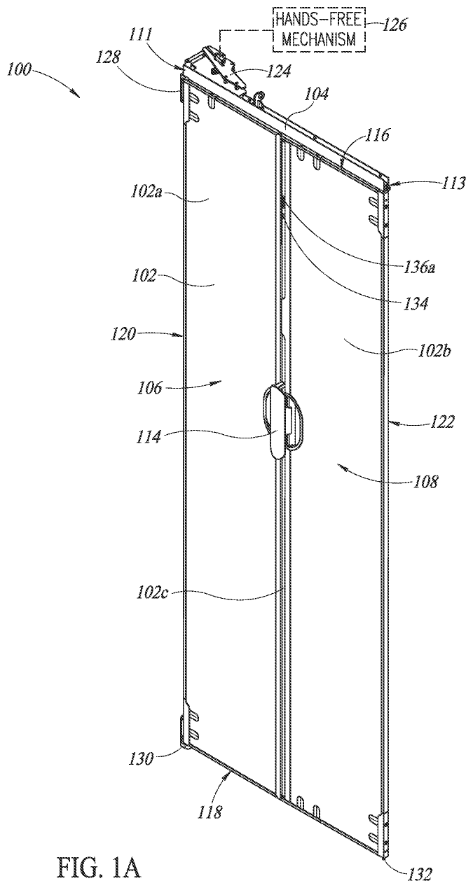

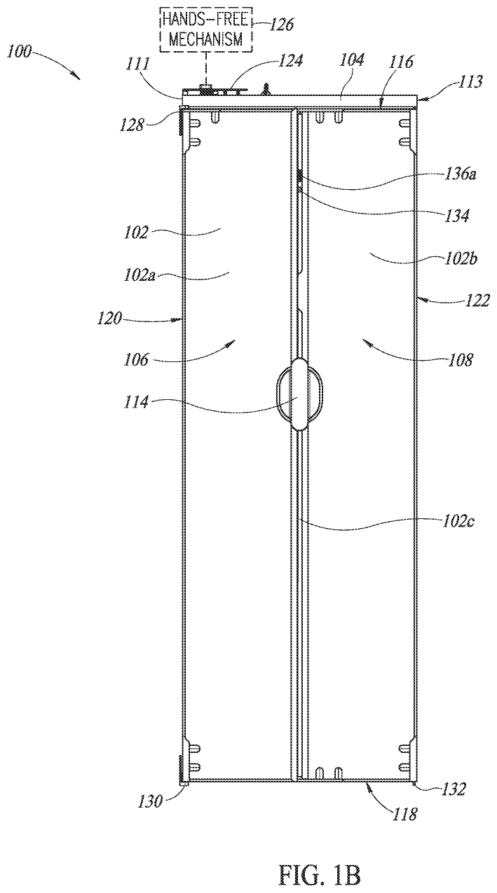

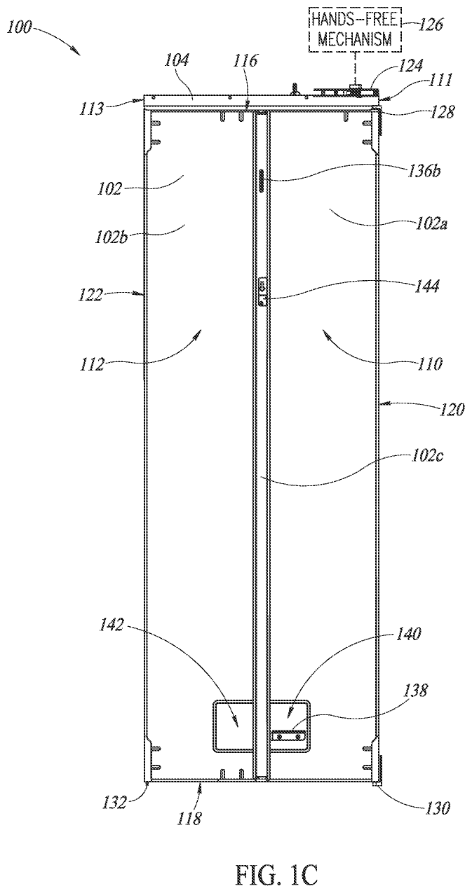

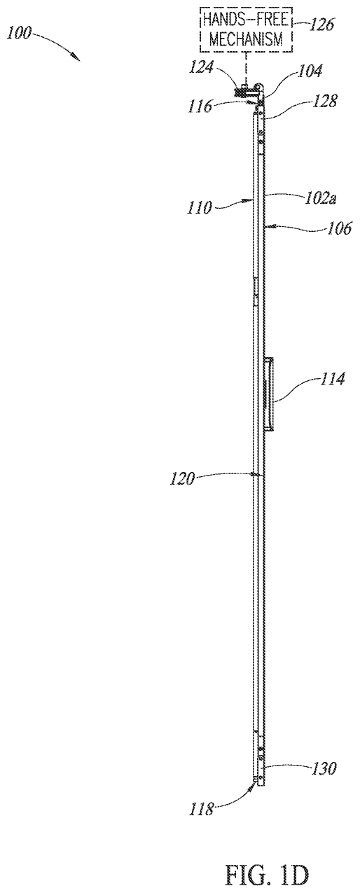

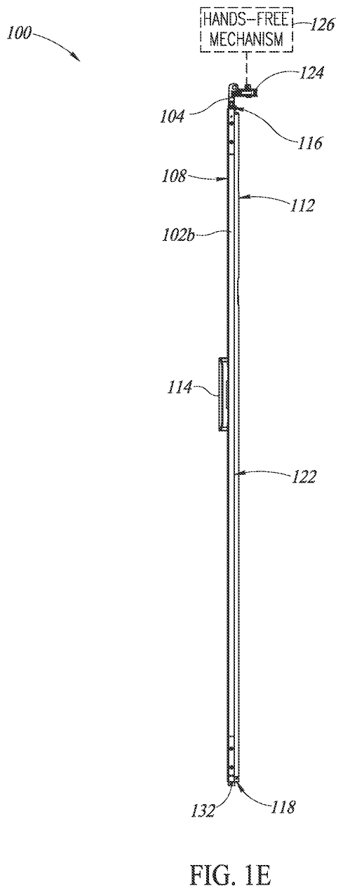

FIG. 1A illustrates a perspective view of a bi-fold door system 100 including a bi-fold door 102 and a header 104 that is in mechanical cooperation with the bi-fold door 102. FIG. 1B illustrates a front view of the bi-fold door system 100 including the bi-fold door 102 and the header 104 that is in mechanical cooperation with the bi-fold door 102.

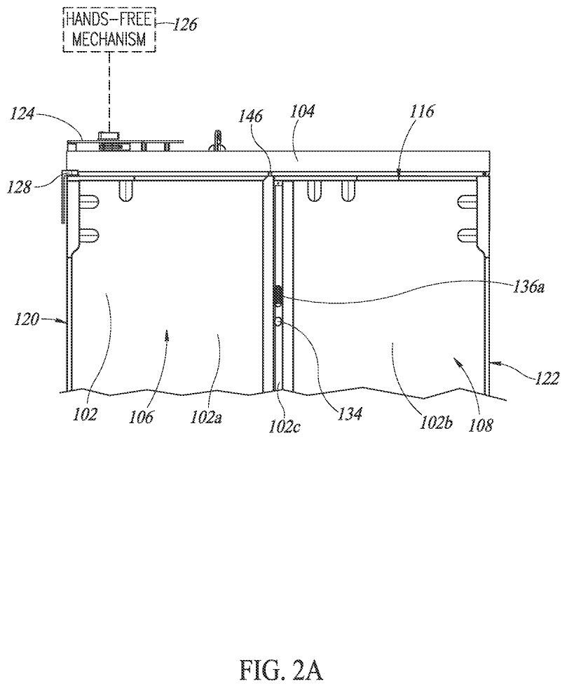

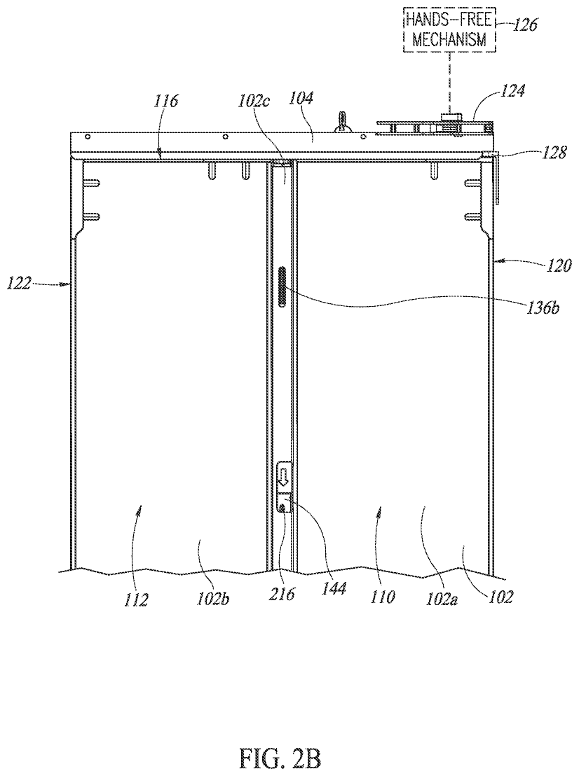

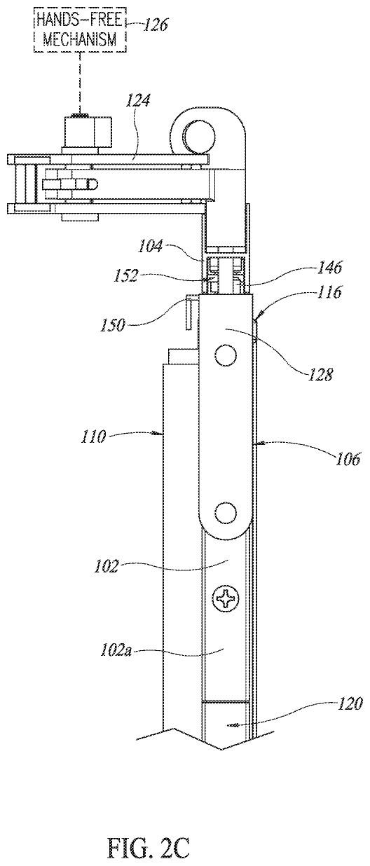

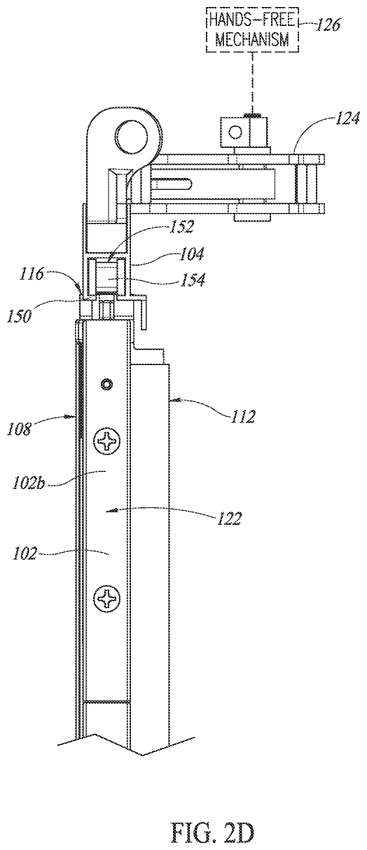

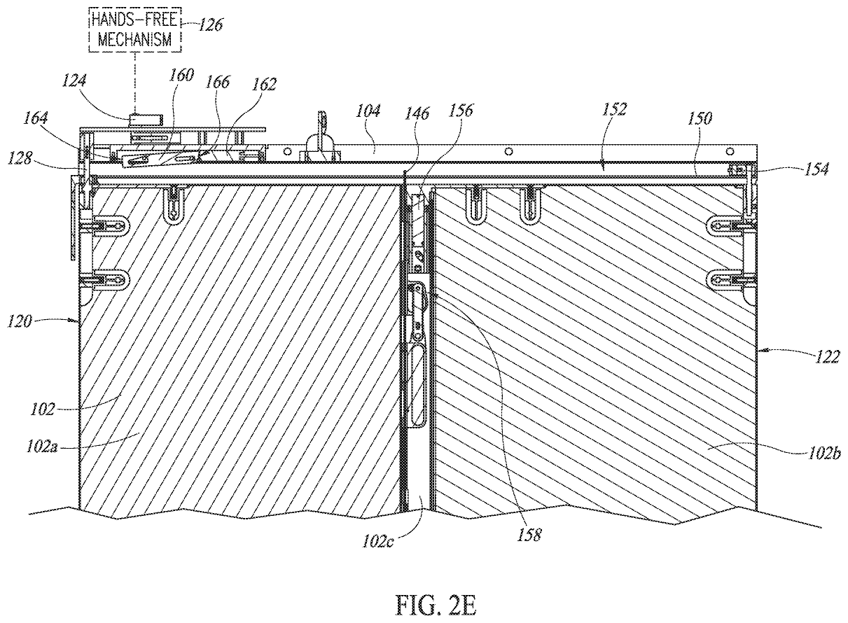

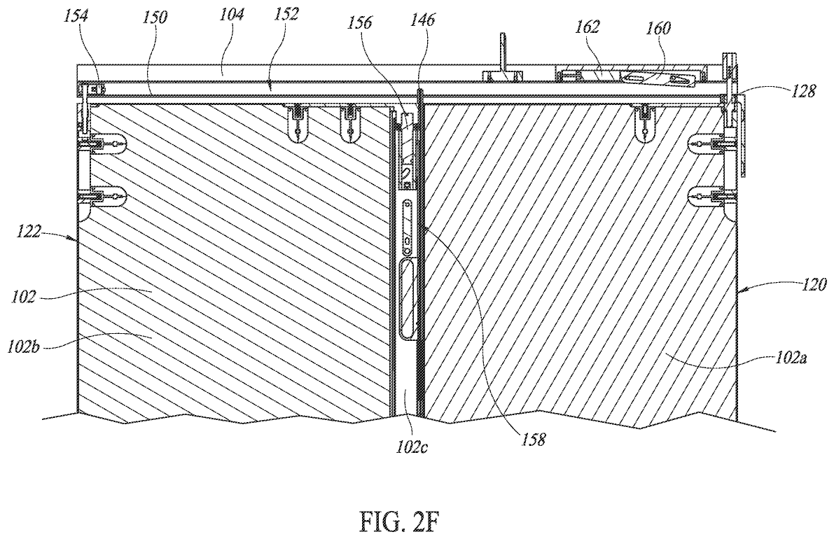

The mechanical cooperation between the bi-fold door 102 and the header 104 will be discussed in further detail with respect to FIG. 2D of the present disclosure. While not fully shown for the sake of brevity and simplicity of the present disclosure, the header 104 may extend from a first jamb of a door frame to a second jamb of the door frame opposite to the first jamb, and the bi-fold door 102 may be mechanically coupled to the first jamb at the left-hand side of the bi-fold door 102 based on the orientation as shown in FIG. 1A.

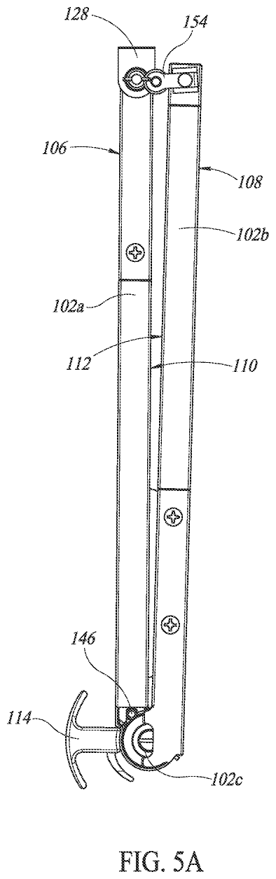

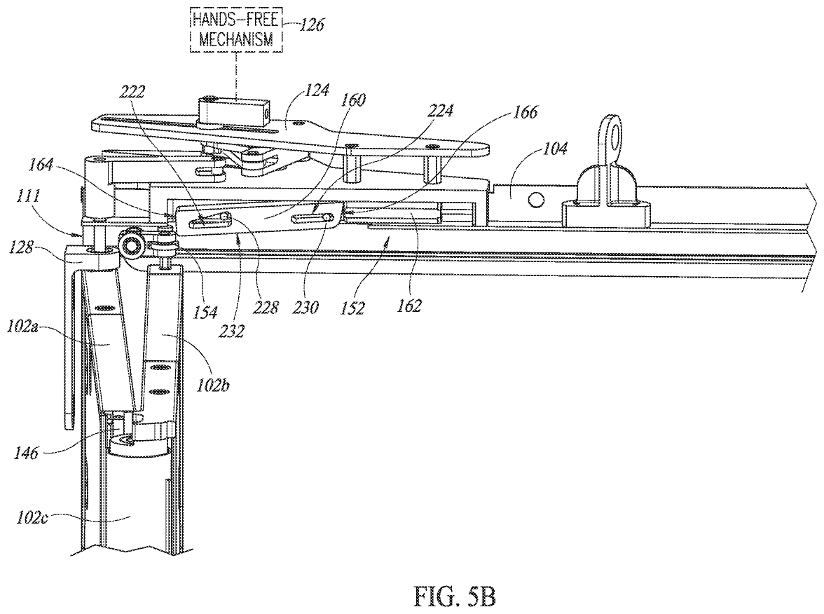

The bi-fold door 102 includes a first panel 102a, a second panel 102b, and a center post 102c. The first panel 102a and the second panel 102b are mechanically coupled together by the center post 102c. The first panel 102a, the second panel 102b, and the center post 102c form an accordion-like structure in which the first panel 102a, the second panel 102b, and the center post 102c may be folded up into an opened position (e.g., folded position), which may more readily be seen in FIGS. 5A and 5B of the present disclosure. When the bi-fold door 102 is in the opened position, a user may enter into a lavatory. The bi-fold door 102 may cover access to the lavatory when the bi-fold door is in a closed position (e.g., expanded position) in which the bi-fold door is expanded.

As will be readily apparent as shown in FIGS. 1A-1E, the bi-fold door 102 is in the closed position (e.g., expanded position) in which the bi-fold door limits access, entry, or ingress into a lavatory of an aircraft. When the bi-fold door 102 is in the closed position, a first external surface 106 of the first panel 102a and a second external surface 108 of the second panel 102b are substantially aligned with each other such that the first and second external surfaces 106, 108 extend along a two-dimensional plane. When the bi-fold door 102 is in the closed position, a first internal surface 110 of the first panel 102a and a second internal surface 112 of the second panel 102b are substantially aligned with each other such that the first and second internal surfaces 110, 112 extend along a two-dimensional plane. The first and second internal surfaces 110, 112, respectively, of the first and second panels 102a, 102b, respectively, may more readily be seen in FIG. 1C of the present disclosure.

The header 104 includes a first end 111 and a second end 113 opposite to the first end 111. The first end 111 is at the left-hand side of the bi-fold door system 100 based on the orientation as shown in FIG. 1B. The second end 113 is at the right-hand side of the bi-fold door system 100 based on the orientation as shown in FIG. 1B.

A handle 114 is present at an exterior of the bi-fold door 102. The handle 114 is mechanically coupled to the center post 102c of the bi-fold door 102. The handle 114 is an ambidextrous handle that allows a user to open the bi-fold door 102 with ease regardless of whether the user is left-hand dominant, right-hand dominant, or ambidextrous. For example, the user may move the bi-fold door 102 from the closed position to the opened position by pulling or pushing on the handle 114 moving the bi-fold door 102 to the left based on the orientation as shown in FIG. 1A. Alternatively, the user may move the bi-fold door 102 from the opened position to the closed position by pulling or pushing on the handle 114 moving the bi-fold door 102 to the right based on the orientation as shown in FIG. 1A.

The bi-fold door 102 further includes a top end 116 (e.g., first end) and a bottom end 118 (e.g., second end) opposite to the top end 116. The first panel 102a, the second panel 102b, and the center post 102c extend from the top end 116 to the bottom end 118 of the bi-fold door 102. The bi-fold door 102 further includes a first side 120 and a second side 122 opposite to the first side 120. The first side 120 is a side of the first panel 102a and is at the left-hand side of the bi-fold door 102 based on the orientation as shown in FIG. 1A. The second side 122 is a side of the second panel 102b and is at the right-hand side of the bi-fold door 102 based on the orientation as shown in FIG. 1A.

The bi-fold door system 100 further includes an automated opening mechanism 124 and a hands-free actuation mechanism 126 that cooperates with the automated opening mechanism 124. The hands-free actuation mechanism 126 is present and accessible within the lavatory such that the user may interact with the hands-free actuation mechanism 126. Interacting with the hands-free actuation mechanism 126 results in actuating the automated opening mechanism 124 moving the bi-fold door 102 from the closed position to the opened position without the user having to physically touch the bi-fold door 102 with their hands. For example, in some embodiments, the hands-free actuation mechanism 126 may be in mechanical cooperation with the automated opening mechanism 124, and, in some alternative embodiments, the hands-free actuation mechanism 126 may be in electrical communication with the automated opening mechanism 124.

In some embodiments, the automated opening mechanism 124 includes a plurality of gears in mechanical cooperation with the hands-free actuation mechanism 126, which is a foot pedal. When the hands-free actuation mechanism 126 is the foot pedal, the user pushes downward (e.g., depresses) on the foot pedal with their foot which articulates and rotates the plurality of gears of the automated opening mechanism. The rotation of the plurality of gears may wind up a wire mechanically coupled to the second side 122 of the second panel 102b. By winding up the wire, the wire pulls on the second side 122 of the second panel 102b resulting in the bi-fold door 102 moving from the closed position (e.g., expanded position) to the opened position (e.g., folded position) in which the first panel 102a, the second panel 102b, and the center post 102c are folded up.

In some alternative embodiments, the automated opening mechanism 124 includes a plurality of gears and an electric motor (e.g., electric step motor) in mechanical cooperation with the plurality of gears, and the hands-free actuation mechanism 126 is in electrical communication with the automated opening mechanism 124. The hands-free actuation mechanism 126 may be a foot pedal, an object detection sensor (e.g., time-of-flight (TOF) sensor, a proximity sensor, or some other type of detection sensor), or some other type of hands-free actuation mechanism configured to send a control signal to the automated opening mechanism 124. For example, when the hands-free actuation mechanism is a proximity sensor, the user positions their hand within a sensing area of the proximity sensor resulting in the proximity sensor sending a control signal to the electric motor such that the electrical motor powers on (e.g., turns on) and rotates the plurality of gears. The rotation of the plurality of gears may wind up a wire mechanically coupled to the second side 122 of the second panel 102b. By winding up the wire, the wire pulls on the second side 122 of the second panel 102b resulting in the bi-fold door 102 moving from the closed position (e.g., expanded position) to the opened position (e.g., folded position) in which the first panel 102a, the second panel 102b, and the center post 102c are folded up.

A first spherical hinge 128 is mechanically coupled to the first side 120 of the first panel 102a of the bi-fold door 102. The first spherical hinge 128 is adjacent to the top end 116 of the bi-fold door 102, and is at the upper left-hand corner of the bi-fold door 102 based on the orientation as shown in FIG. 1A. The first spherical hinge 128 is closer to the top end 116 than the bottom end 118.

A second spherical hinge 130 is mechanically coupled to the first side 120 of the first panel 102a of the bi-fold door 102. The second spherical hinge 130 is adjacent to the bottom end 118 of the bi-fold door 102, at the lower left-hand corner of the bi-fold door 102 based on the orientation as shown in FIG. 1A. The second spherical hinge 130 is closer to the bottom end 118 than the top end 116.

While not readily shown, the first and second spherical hinges 128, 130 couple the bi-fold door 102 to a first jamb of a door frame at the left-hand side of the bi-fold door 102. The first and second spherical hinges 128, 130 have degrees-of-freedom (e.g., rotational degrees-of-freedom) relative to the first jamb to accommodate deflection of the bi-fold door 102 while the aircraft is underway (e.g., flying). The deflection of the bi-fold door 102 to be accommodated by the first and second spherical hinges 128, 130 may be a result of turbulence, vibration, or some other such external stresses and forces as a result of the aircraft being underway (e.g., flying). For example, in at least one such example, when the bi-fold door 102 begins to rotate in a counter-clockwise direction, the first and second spherical hinges 128, 130 allow the bi-fold door 102 to rotate in the counter-clockwise direction to accommodate the deflection of the bi-fold door due to the counter-clockwise rotation of the bi-fold door 102. In view of this accommodation of deflection of the bi-fold door 102 by the first and second spherical hinges 128, 130, the likelihood of the bi-fold door 102 binding up (e.g., becoming jammed, becoming stuck, etc.) is reduced improving a user's experience when moving the bi-fold door 102 from the closed position to the opened position and vice versa when the aircraft is underway (e.g., flying).

A guide pin 132 is at the bottom end 118 of the bi-fold door 102. The guide pin 132 is at the bottom right-hand corner of the bi-fold door 102 based on the orientation as shown in FIG. 1A. While not shown, the guide pin 132 is in mechanical cooperation with a threshold or a sill of a door frame. The threshold or sill includes a track along which the guide pin 132 travels or slides along when moving the bi-fold door 102 from the closed position to the opened position and vice versa to direct the bi-fold door 102 along the track in the threshold or the sill. The guide pin 132 may be spring loaded such that if the guide pin 132 is displaced out of the track within the threshold or the sill of the door frame, the guide pin 132 may be depressed and reinserted into the track of the threshold or the sill of the door frame without utilization of tools.

A lock indicator 134 is present along the center post 102c of the bi-fold door 102. The lock indicator 134 indicates when the bi-fold door 102 is locked or is unlocked. For example, when locked, the lock indicator 134 may display a red color with a “locked” symbol (e.g., locked padlock symbol, an “occupied” label, or some other symbol, label, or indicator that the lavatory is occupied) such that an individual attempting to access the lavatory is informed that another individual is already present within and occupying the lavatory. Similarly, when unlocked, the lock indicator 134 may display a green color with an “unlocked” symbol (e.g., unlocked padlock symbol, an “unoccupied” label, or some other symbol, label or indicator that the lavatory is unoccupied) such that an individual attempting to access the lavatory is informed that the lavatory is currently unoccupied by another individual. In other words, the lock indicator 134 is readily visible at an exterior of the bi-fold door 102 to inform an individual attempting to access the lavatory as to whether the lavatory is or is not currently occupied.

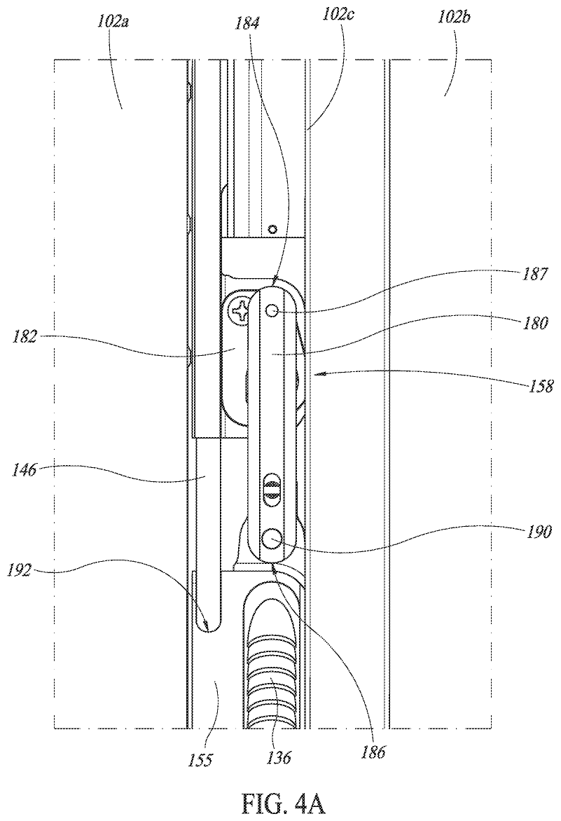

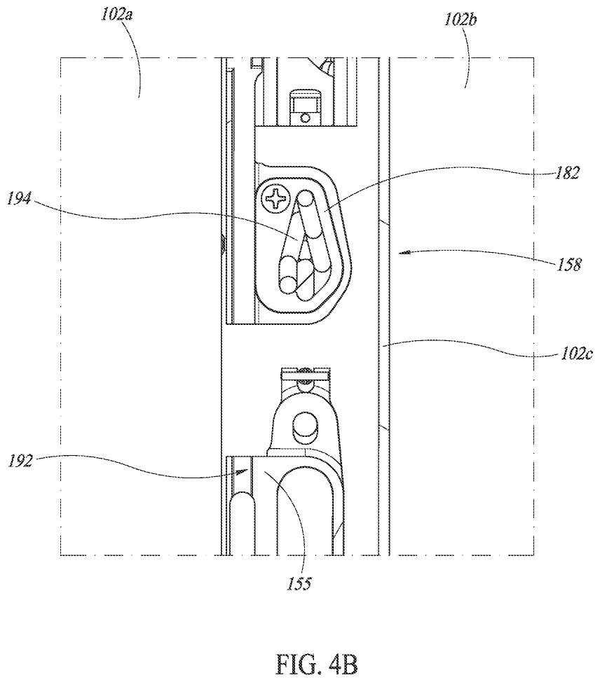

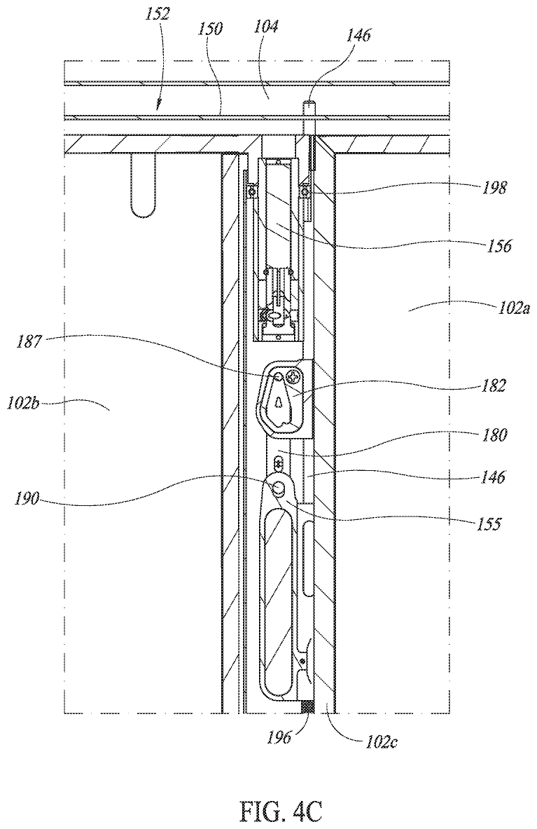

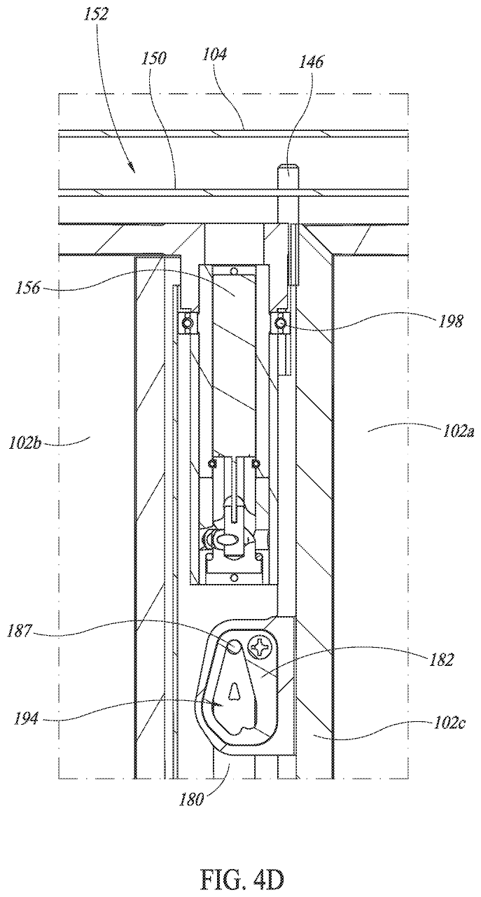

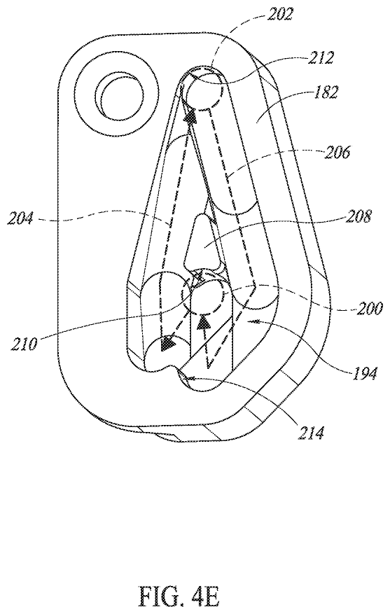

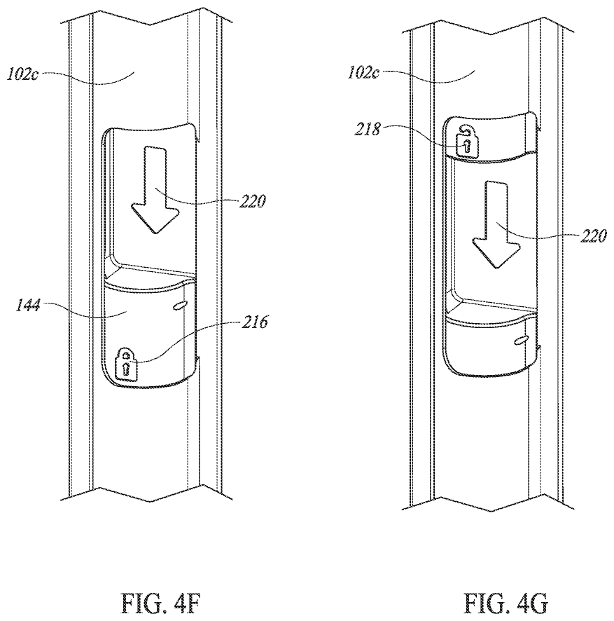

A slide component 155, which may be more readily seen in FIG. 4A, is along the center post 102c of the bi-fold door 102. The slide component 155 includes a first lock override opening 136a that is accessible at the exterior of the bi-fold door 102. The first lock override opening 136a is configured to unlock the bi-fold door 102 from outside the lavatory. For example, in some embodiments, the first lock override opening 136a may be keyed in which a specialized tool (e.g., specialized key) is inserted into the first lock override opening 136a and the specialized tool is pulled down to move the slide component 155 downward to unlock the bi-fold door 102. In some other alternative embodiments, the first lock override opening 136a may be configured to be unlocked by a specialized tool such as a specialized tool with multiple prongs that are inserted into the first lock override opening 136a. In yet some other alternative embodiments, the slide component 155 with the first lock override opening 136a may be articulable by a finger of an individual outside the lavatory to unlock the bi-fold door 102. The slide component 155 includes a lock override structure 136 that is accessible through the first lock override opening 136a and the second lock override opening 136b. The lock override structure 136 may be utilized to unlock the bi-fold door 102 from the exterior of the bi-fold door 102 outside the lavatory in the event of an emergency (e.g., an individual injured within the lavatory due to an abrupt shift in movement while the aircraft is flying).

FIG. 1C illustrates a rear view of the bi-fold door system 100 including the bi-fold door 102 and the header 104. As discussed earlier, the first panel 102a includes the first internal surface 110 and the second panel 102b includes the second internal surface 112.

A foot pedal 138 is present at an interior of the bi-fold door 102. The foot pedal is present in a first indentation 140 at the internal surface 110 of the first panel. The foot pedal 138 is in mechanical cooperation with an escapement mechanism 158 through a lock rod 146 and the slide component 155. When the foot pedal 138 is depressed and the bi-fold door 102 is unlocked in the closed position, the foot pedal 138 mechanically cooperates with the lock rod 146 and the lock rod 146 mechanically cooperates with the escapement mechanism 158 such that the lock rod 146 moves from an unlocked state (e.g., retracted position and/or state) to a locked state (e.g., extended position and/or state). When in the locked state, the lock rod 146 locks the bi-fold door 102 in the closed position. For example, when the foot pedal 138 is depressed, the lock rod 146 extends upward and is inserted into an opening (not shown) in the header 104 such that the lock rod 146 interlocks with the header 104 and locks the bi-fold door 102 in the closed position. When the foot pedal 138 is depressed and the lock rod 146 is in the locked state locking the bi-fold door 102 in the closed position, the foot pedal 138 mechanically cooperates with the lock rod 146 and the lock rod 146 mechanically cooperates with the escapement mechanism 158 to move the lock rod 146 from the locked state (e.g., extended position and/or state) to the unlocked state (e.g., retracted position and/or state). When in the unlocked state, the lock rod 146 is retracted from the opening (not shown) in the header 104 such that the bi-fold door 102 may be readily moved from the closed position to the opened position and vice versa. Further details of the mechanical cooperation of the foot pedal 138, the lock rod 146, and the escapement mechanism 158, and the lock rod 146 will be discussed in further detail herein with respect to FIG. 4E.

A second indentation 142 is at the internal surface 112 of the second panel 102b. The second indentation may be a mirror image of the first indentation 140. When the bi-fold door 102 is in the closed position, the foot pedal 138 may extend into the second indentation 142. In other words, the second indentation 142 receives the foot pedal 138 such that the bi-fold door 102 may be folded up into the opened position without being inhibited by the foot pedal 138. The second indentation 142 provides enough clearance for the foot pedal 138 to be received within the second indentation 142 when the bi-fold door 102 is in the opened position such that the foot pedal 138 does not obstruct the bi-fold door 102 being in the opened position. In an alternative embodiment, the foot pedal 138 may be in the second indentation 142 and the first indentation 140 may receive the foot pedal 138 when the bi-fold door 102 is in the closed position.

A hand lever 144 is present along the center post 102c of the bi-fold door 102. The hand lever 144 is in mechanical cooperation with the escapement mechanism 158 by the lock rod 146. For example, the hand lever 144 may be mechanically coupled to the lock rod 146 such that when the hand lever 144 is moved downward the lock rod 146 is moved downward from the locked state (e.g., extended position and/or state) to the unlocked state (e.g., retracted position and/or state) or vice versa. The hand lever 144 may be an additional option for actuating the lock rod 146 such that the lock rod 146 may be moved from the locked state to the unlocked state and vice versa by either the foot pedal 138 or the hand lever 144 separately. In other words, a user may use either the foot pedal 138 or the hand lever 144 to move the lock rod 146 from the locked state to the unlocked state and vice versa depending on a preference of the user. For example, a user may lack physical motor skills to actuate the foot pedal 138 with their foot but may have physical motor skills to actuate the hand lever 144 with their hand. Alternatively, a user may lack physical motor skills to actuate the hand lever 144 with their hand but may have physical motor skills to actuate the foot pedal 138 with their foot. In other words, the foot pedal 138 and the hand lever 144 provide various options depending on the preference or needs of a user present within the lavatory.

As shown in FIG. 1C, the center post 102c includes a second lock override opening 136b, accessible at the interior of the bi-fold door 102 along the center post 102c. Similar to how the first lock override opening 136a could be utilized in an emergency to unlock the bi-fold door 102 to enter the lavatory, the second lock override opening 136b may be utilized to unlock the bi-fold door 102 such that a user may be provided with another option to unlock the bi-fold door 102 to exit the bi-fold door 102. For example, the second lock override opening 136b may be utilized in the event the foot pedal 138, the hand lever 144, or the escapement mechanism 158 breaks such that the bi-fold door 102 may only be unlocked utilizing the second lock override opening 136b to exit the lavatory. The second lock override opening 136b provides access to the lock override structure 136 of the slide component 155.

FIG. 1D illustrates a left-side view of the bi-fold door system 100 including the bi-fold door 102 and the header 104. FIG. 1E illustrates a right-side view of the bi-fold door system 100 including the bi-fold door 102 and the header 104.

FIG. 2A illustrates an enlarged, partial view of a front section at the top end 116 of the bi-fold door 102. As shown in FIG. 2A, the lock rod 146 is in the locked state (e.g., extended position and/or state) in which the lock rod 146 extends into the opening (not shown) in the header 104 locking the bi-fold door 102 in the closed position. When the lock rod 146 is in the locked state the bi-fold door 102 may not readily be moved from the closed position to the opened position.

FIG. 2B illustrates an enlarged, partial view of a rear section at the top end 116 of the bi-fold door 102. As shown in FIG. 2B, the hand lever 144 is in the locked position such that a “locked” indicator 216 (e.g., symbol of a “locked” padlock) is visible such that a user within the lavatory is informed that the bi-fold door 102 is locked in the closed position.

FIG. 2C illustrates an enlarged, partial view of an upper left-hand corner of the bi-fold door 102 as shown in FIG. 1A at the top end 116 of the bi-fold door 102. As shown in FIG. 2C, the lock rod 146 is in the locked state (e.g., extended position and/or state) in which the lock rod 146 extends into the opening (not shown) in the header 104 locking the bi-fold door in the closed position. As may readily be seen in FIG. 2C, the lock rod 146 extends through the opening (not shown) present in a horizontal portion 150 of the header 104 based on the orientation as shown in FIG. 2C. The lock rod 146 interlocks with the horizontal portion 150 of the header 104 locking the bi-fold door in the closed position such that the bi-fold door may not be readily moved from the closed position to the opened position limiting access or entry into the lavatory.

The header 104 further includes a track 152 extending through the header 104 from the first end 111 to the second end 113 of the header 104. In this embodiment of the bi-fold door system 100, the header 104 is an H-channel bracket and has an H-shape as readily visible in FIG. 2C.

FIG. 2D illustrates an enlarged, partial view of the upper right-hand corner of the bi-fold door system 100 as shown in FIG. 1A at the top end 116 of the bi-fold door 102. As shown in FIG. 2D, a track follower 154 is mechanically coupled to the top end 116 of the bi-fold door 102. The track follower 154 is mechanically coupled to the upper right-hand corner of the second panel 102b based on the orientation as shown in FIG. 2D. The track follower 154 may be a wheel, a slider, or some other type of track follower component that may be in mechanical cooperation with the track 152 of the header 104. The track follower 154 is in mechanical cooperation with the track 152 of the header 104 such that the track follower 154 moves along and through the track 152 of the header 104. For example, when the lock rod 146 is in the unlocked state (e.g., retracted state) in which the lock rod 146 is retracted into the center post 102c, a user may readily move the bi-fold door from the closed position to the opened position to access the lavatory. When the bi-fold door 102 moves from the closed position towards the opened position, the track follower 154 moves along track 152 of the header 104 from right to left based on the orientation of the bi-fold door 102 as shown in FIG. 1B. As the bi-fold door 102 moves from the right to the left, the bi-fold door 102 folds outward and away from the lavatory such that the bi-fold door extends away from the lavatory. This outward folding orientation of the bi-fold door 102 when in the fully opened position may readily be seen in FIGS. 5A and 5B of the present disclosure. When the bi-fold door 102 is in the fully opened position (e.g., completely folded up in the opened position as shown in FIGS. 5A and 5B), the track follower 154 is in close proximity to the first end 111 of the header 104 relative to a position of the track follower 154 when the bi-fold door 102 is in the closed position. In other words, the track follower 154 is closer to the first end 111 when the bi-fold door 102 is in the fully opened position relative to a position of the track follower when the bi-fold door 102 is in the fully closed position.

Alternatively, when the bi-fold door 102 is in the opened position and moves towards the closed position, the bi-fold door 102 unfolds and expands as the bi-fold door 102 moves from left to right from the opened position towards the closed position. When moving the bi-fold door 102 from opened position to the closed position, the track follower 154 moves along the track 152 of the header 104 from left to right based on the orientation of the bi-fold door 102 as shown in FIG. 1B. When the bi-fold door 102 is in the fully closed position (e.g., completely expanded and unfolded such that the bi-fold door covers the lavatory as shown in FIGS. 1A-1E), the track follower 154 is in close proximity to the second end 113 of the header relative to a position of the track follower 154 when the bi-fold door 102 is in the closed position. In other words, the track follower 154 is closer to the second end 113 of the header 104 when the bi-fold door 102 is in the fully closed position relative to a position of the track follower 154 when the bi-fold door 102 is in the fully opened position.

When the bi-fold door 102 is at an intermediate position between the fully closed position as shown in FIGS. 1A-1E and the fully opened position as shown in FIGS. 5A and 5B, the bi-fold door 102 may be partially folded or partially expanded by some amount between when the bi-fold door 102 is in the fully opened position and in the fully closed position. For example, when the bi-fold door 102 is at the intermediate position between the fully closed position and the fully opened position, the track follower 154 is at an intermediate position between the first end 111 and the second end 113 of the header 104. In other words, the track follower 154 is at an intermediate position somewhere between a position of the track follower 154 when the bi-fold door 102 is in the fully opened position and a position of the track follower 154 is in the fully closed position.

FIG. 2E is an enlarged, partial front side sectional view of the top end 116 of the bi-fold door 102 taken along a plane passing through the first panel 102a, the second panel 102b, the center post 102c, and the header 104 such that components within the bi-fold door 102 and the header 104 are readily visible.

A rotary dampener 156 is present within and along the center post 102c. The rotary dampener 156 is in mechanical cooperation with the bi-fold door 102. The rotary dampener 156 may slow down the bi-fold door 102 as the bi-fold door is moved into the fully closed position or the fully opened position to reduce the likelihood of a user slamming or pinching their fingers, hand, or appendage within the bi-fold door 102. For example, as the bi-fold door 102 expands into the fully closed position, the rotary dampener slows down to a speed at which the bi-fold door 102 moves into the fully closed position such that if a user's finger is present on a jamb of the door frame, the user's finger is not injured if the user's finger is in a path of the bi-fold door 102.

The escapement mechanism 158 is present within and along the center post 102c. The escapement mechanism 158 is in mechanical cooperation with the foot pedal 138 and the lock rod 146. For example, the escapement mechanism 158 transmits actuation of the foot pedal 138 to the lock rod 146 to move the lock rod 146 from the locked state (e.g., extended position and/or state) to the unlocked state (e.g., extended position and/or state) or vice versa. The details and functionality of the escapement mechanism 158 will be discussed with respect to FIGS. 4A-4E.

A catch 160 is present within and along the header 104, and a dampener 162 is present within and along the header 104. The catch 160 includes a first end 164 and a second end 166 opposite to the first end 164, and the first end 164 extends into the track 152 of the header 104 and the second end 166 abuts the dampener 162. For example, a lower left-hand corner at the first end 164 of the catch 160, based on the orientation as shown in FIG. 2E, extends into the track 152 of the header 104. The details and functionality of the catch 160 and the dampener 162 will be discussed with respect to FIG. 5B.

FIG. 2F is an enlarged, partial rear side sectional view of the top end 116 of the bi-fold door 102 taken along a plane passing through the first panel 102a, the second panel 102b, the center post 102c, and the header 104 such that components within the bi-fold door 102 and the header are readily visible.

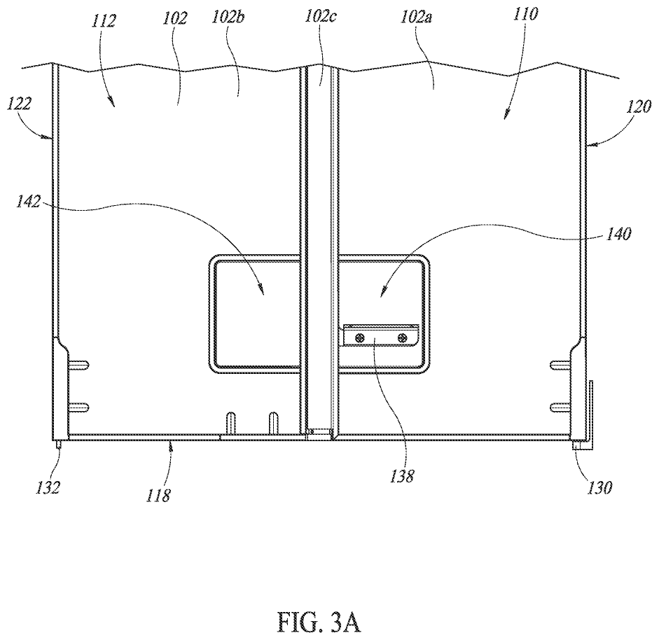

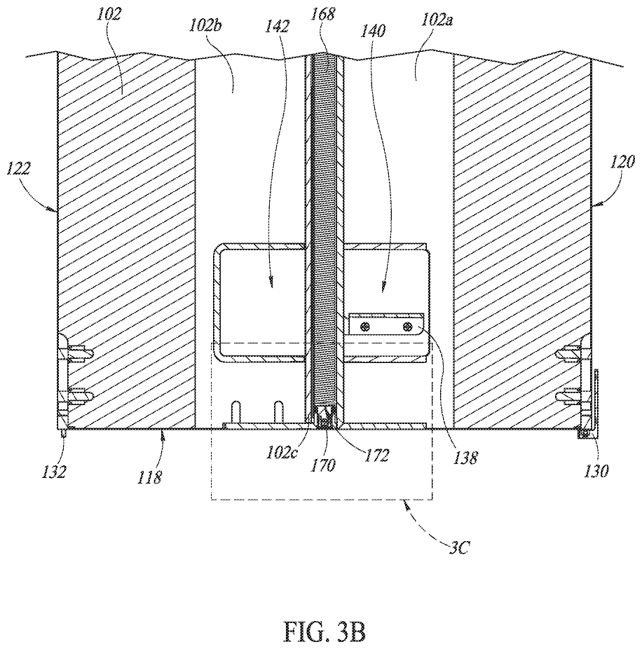

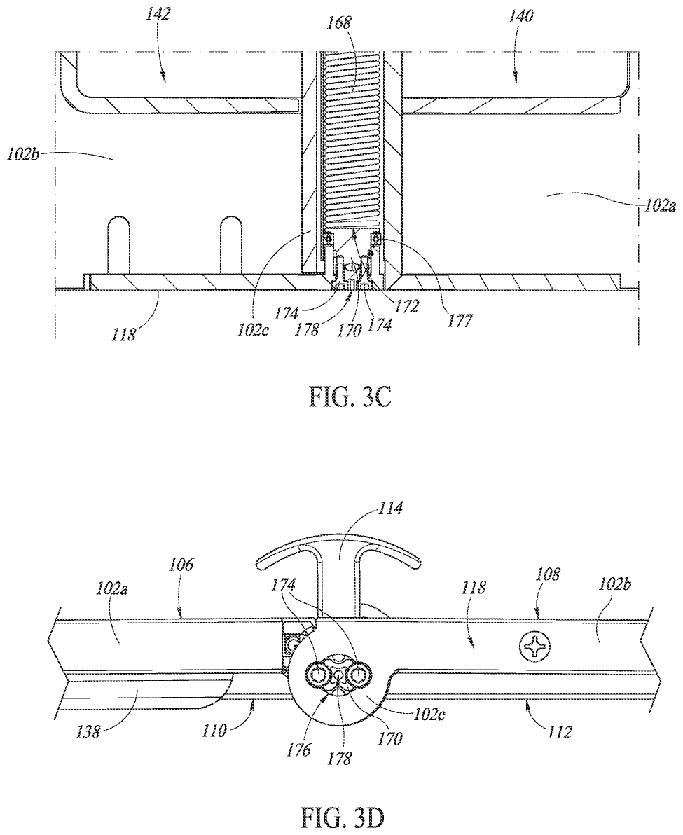

FIG. 3A is an enlarged, partial view of a rear section at the bottom end 118 of the bi-fold door 102 of the bi-fold door system 100 as shown in FIGS. 1A-1E. FIG. 3B is an enlarged, partial rear side sectional view of the bottom end 118 of the bi-fold door 102 taken along a plane passing through the first panel 102a, the second panel 102b, the center post 102c, and the header 104 such that components within the bi-fold door 102 and the header 104 are readily visible.

A torsional spring 168 is within and along the center post 102c of the bi-fold door 102. The torsional spring 168 extends away from the bottom end 118 of the bi-fold door 102 towards the top end 116 of the bi-fold door 102. The torsional spring 168 terminates at a location along the center post 102c between the bottom end 118 and the top end 116 of the bi-fold door 102. For example, the torsional spring 168 may have an upper end (not shown) at which the torsional spring 168 terminates before the torsional spring 168 reaches the hand lever 144 along the center post 102c of the bi-fold door 102. The torsional spring 168 is biased towards the closed position such that the torsional spring 168 applies a torque that moves the bi-fold door away from the opened position towards the closed position. The torque applied by the torsional spring 168 to the bi-fold door 102 is overcome when a user applies enough force to the bi-fold door 102 to move the bi-fold door 102 away from the closed position towards the opened position. If the bi-fold door 102 is released by a user when in the opened position, the torsional spring 168 biased towards the closed position may apply enough torque to the bi-fold door 102 such that the bi-fold door 102 moves to the fully closed position by the torque applied by the torsional spring 168.

As discussed earlier, the rotary dampener 156 may slow down the bi-fold door 102 as the bi-fold door is moved into the fully closed position or the fully opened position to reduce the likelihood of a user slamming or pinching their fingers, hand, or appendage within the bi-fold door 102. For example, as the bi-fold door 102 expands into the fully closed position, the rotary dampener 156 may partially oppose the torque applied to the bi-fold door 102 by the torsional spring 168. The partial opposition by the rotary dampener 156 slows down the speed at which the bi-fold door 102 moves into the fully closed position such that if a user's finger is present on a jamb of the door frame the user's finger is not injured if the user's finger is in a path of the bi-fold door 102. Alternatively, as the bi-fold door folds up into the fully opened position, the rotary dampener 156 may partially oppose the torque applied to the bi-fold door 102 by the user such that the rotary dampener 156 slows down the speed at which the bi-fold door 102 moves into the fully opened position such that if the user's finger is between the first and second panels 102a, 102b, the user's finger is not injured by being pinched between the first and second panels 102a, 102b. In some embodiments, the rotary dampener 156 may not be configured to slow down the speed at which the bi-fold door 102 moves when moving into the fully opened position as the torsional spring 168 may instead apply a torque to the bi-fold door 102 to slow down the speed of the bi-fold door 102.

A rotation component 170 is present at an end of the center post 102c at the bottom end 118 of the bi-fold door 102. The rotation component 170 is in mechanical cooperation with the torsional spring. The rotation component 170 is mechanically coupled to a lower end 172 of the torsional spring 168 opposite to the upper end of the torsional spring 168.

The rotation component 170 is locked in place by a plurality of fasteners 174 that interlock with the rotation component 170. The plurality of fasteners 174 lock the rotation component 170 in a fixed position such that the rotation component 170 may not rotate when the plurality of fasteners 174 (see, e.g., FIG. 3C) are interlocked with the rotation component 170.

FIG. 3C is an enlarged, partial view of a section of the bi-fold door 102 enclosed by the dotted rectangle 3C as shown in FIG. 3B. A first ball bearing 177 is present at the bottom end of the center post 102c at the bottom end 118 of the bi-fold door 102. The first ball bearing 177 is along and within the center post 102c. The first ball bearing 177 is free to translate vertically while also being free to rotate to accommodate the deflection of the bi-fold door 102 while an aircraft is underway (e.g., flying). The first ball bearing 177 reduces the likelihood of the bi-fold door 102 (e.g., the first panel 102a and/or the second panel 102b) binding up (e.g., being jammed, being stuck, etc.) such that the bi-fold door 102 may not be readily or easily moved from the opened position to the closed position or vice versa. In view of this accommodation of deflection of the bi-fold door 102 by the first ball bearing 177, the likelihood of the bi-fold door 102 binding up (e.g., becoming jammed, becoming stuck, etc.) is reduced improving a user's experience when moving the bi-fold door 102 from the closed position to the opened position and vice versa when the aircraft is underway (e.g., flying).

FIG. 3D is a bottom side enlarged, partial view of the end of the center post 102c, the plurality of fasteners 174, and ends of the first and second panels 102a, 102b at the bottom end 118 of the bi-fold door 102. An end of the rotation component 170 is exposed from the lower end of the center post 102c by an opening 176 such that a reception opening 178 of the rotation component 170 is readily accessible through the opening 176. The reception opening 178 is structured to readily receive a tool or a specialized tool for rotating the rotation component 170 when the plurality of fasteners 174, which hold the rotation component in the fixed position, are removed. For example, the specialized tool may have a prong that is to be readily inserted into the reception opening 178 at which point the specialized tool is rotated to tighten or loosen the torsional spring 168. The rotation component 170 may be utilized to wind up (e.g., rotate) the torsional spring 168 in a counterclockwise direction or a clockwise direction to increase or decrease a torque applied by the torsional spring 168 biased towards the closed position to the bi-fold door 102.

When tightening or loosening the torsional spring 168, a user (e.g., maintenance employee, flight crew member, etc.) removes the plurality of fasteners 174 such that the rotation component 170 is no longer held in the fixed position by the plurality of fasteners 174 and is readily rotatable. The user may insert the specialized tool into the reception opening 178 of the rotation component 170 such that the specialized tool stops the torsional spring 168 from rotating once the plurality of fasteners 174 are removed. After the plurality of fasteners 174 are removed, the user then rotates the specialized tool rotating the rotation component 170 either in a clockwise or counterclockwise rotation. As the rotation component 170 is in mechanical cooperation with or mechanically coupled to the torsional spring 168, the rotation of the rotation component 170 is transferred to the torsional spring 168 either tightening or loosening the torsional spring 168. This customizes and adjusts the torque applied to the bi-fold door 102 by the torsional spring 168. Once the user has tightened or loosened the torsional spring 168 by rotating the specialized tool when inserted into the reception opening 178, the user reinserts the plurality of fasteners 174 such that the rotation component 170 is held in the fixed position.

In other words, the rotation component 170 may be utilized to tighten or loosen the torsional spring 168 to customize and adjust the torque applied to the bi-fold door 102 by the torsional spring 168. The customizable and adjustability of the torsional spring 168 provides a useful life-span of the torsional spring 168 to be increased by reducing stresses applied to the torsional spring 168 due to the torsional spring 168 either being too tight or too loose when in use or when an aircraft is underway (e.g., flying).

The torsional spring 168 is relatively large as compared to conventional torsional spring utilized in conventional bi-fold doors within the aircraft industry such that the torsional spring 168 of the present disclosure has an increased useful life-span as compared to the conventional torsional springs, which are smaller, utilized in the conventional bi-fold doors. For example, the torsional spring 168 may be longer, may be a larger diameter, and may have a greater number of coils relative to conventional torsional springs utilized within the aircraft industry.

FIG. 4A is an enlarged front sectional view of the escapement mechanism 158 as shown in FIG. 2E along the center post 102c. The escapement mechanism 158 includes a member 180 and a track component 182.

The member 180 includes an upper end 184, a lower end 186 that is opposite to the upper end 184, and a track pin 187 that is closer to the upper end 184 than the lower end 186 of the member 180. The track pin 187 is in mechanical cooperation with the track component 182 of the escapement mechanism 158, the lower end 186 is in mechanical cooperation with the slide component 155 by at least one pin 190, and the slide component 155 is in mechanical cooperation with the lock rod 146. For example, the slide component 155 includes an opening 192 through which the lock rod 146 passes through such that the lock rod 146 is in mechanical cooperation with the slide component 155. The pin 190 is closer to the lower end 186 than the upper end 184. The member 180 is along the center post 102c and may be within the center post 102c.

FIG. 4B is an enlarged front sectional view of the escapement mechanism 158 with the member 180 hidden such that the track component 182 is more readily visible. The sectional view in FIG. 4B is slightly different than the sectional view in FIG. 4A. The track component 182 includes a pin track 194 that receives the track pin 187 such that the track pin 187 slideably moves along the pin track 194 when moving the lock rod 146 from the locked state to the unlocked state or vice versa. The interaction of the track pin 187 of the lock rod 146 and the track 194 of the escapement mechanism 158 will be discussed in further detail with respect to FIG. 4E. FIG. 4C is an enlarged, partial rear sectional view of the escapement mechanism 158 along the center post 102c. At least one spring 196 is on and around the lock rod 146 and is in mechanical cooperation with the slide component 155 and the lock rod 146. The at least one spring 196 may be a compression spring that applies an opposing force to the slide component 155 when the slide component 155 is pushed against the at least one spring 196.

FIG. 4D is an enlarged, partial view of a section of the enlarged, partial rear sectional view at the top end 116 of the embodiment of the bi-fold door 102 as shown in FIG. 4C. A second ball bearing 198 is present at the top end of the center post 102c. The second ball bearing 198 is around the rotary dampener 156. Similar to the first ball bearing 177, the second ball bearing 198 is along and within the center post 102c. The second ball bearing 198 is free to translate vertically while also being free to rotate to accommodate the deflection of the bi-fold door 102 while an aircraft is underway (e.g., flying). The second ball bearing 198 reduces the likelihood of the bi-fold door 102 (e.g., the first panel 102a and/or the second panel 102b) binding up (e.g., being jammed, being stuck, etc.) such that the bi-fold door 102 may not be readily or easily moved from the opened position to the closed position or vice versa. In view of this accommodation of deflection of the bi-fold door 102 by the second ball bearing 198, the likelihood of the bi-fold door 102 binding up (e.g., becoming jammed, becoming stuck, etc.) is reduced improving a user's experience when moving the bi-fold door 102 from the closed position to the opened position and vice versa when the aircraft is underway (e.g., flying). By having the first ball bearing 177 at the bottom end and the second ball bearing 198 at the top end of the center post 102c, likelihood of the first and second panels 102a, 102b binding up due to displacement of the bi-fold door 102 while the aircraft is underway (e.g., flying) is reduced as the first and second panel 102a, 102b may readily translate vertically and rotate due to the first and second ball bearings 177, 198, respectively.

FIG. 4E is a perspective view of the track component 182 of the escapement mechanism 158 such that the track 194 of the track component 182 is more readily and easily visible. As discussed earlier, the track pin 187 moves along the track 194 from a first position 200 to a second position 202.

The track pin 187 moves along a first pathway 204 of the track 194 from the first position 200 to the second position 202 such that the lock rod 146 is moved from a retracted position to an extended position resulting in the bi-fold door 102 being in the locked state. In other words, the bi-fold door 102 goes from being unlocked to locked such that the bi-fold door 102 may not be readily moved from the closed position to the opened position such that one may not readily enter or exit the lavatory through the bi-fold door 102.

The track pin 187 moves along a second pathway 206 of the track 194 from the second position 202 to the first position 200 such that the lock rod 146 is moved from the extended position to the retracted position resulting in the bi-fold door 102 being in the unlocked state. In other words, the bi-fold door goes from being locked to unlocked such that the bi-fold door 102 may be readily moved from the closed position to the opened position to enter or exit the lavatory through the bi-fold door 102.

When locking the bi-fold door 102, a user (e.g., an individual utilizing the bathroom to defecate and/or urinate) moves the bi-fold door 102 from the opened position to the closed position. After the bi-fold door 102 is fully in the closed position, the user releases the bi-fold door 102, which may be held in the fully closed position by the torsional spring 168, and the user presses down on the foot pedal 138 with their foot actuating the foot pedal 138. As the foot pedal 138 is actuated by being depressed by the user's foot, the foot pedal 138 mechanically cooperates such that the lock rod 146 moves downward along with the foot pedal 138. As the lock rod 146 moves downward, the lock rod 146 mechanically cooperates with the slide component 155 such that the slide component 155 moves downward along with the lock rod 146 and pushes against the at least one spring 196. The slide component 155 at least partially compresses the at least one spring 196, which applies an opposing force in an upward direction to the slide component 155. The upward direction is opposite to the downward direction of which the slide component 155 is moving along with the lock rod 146 when the foot pedal 138 is depressed.

As the slide component 155 moves downward, the slide component 155 mechanically cooperates with the member 180 of the escapement mechanism 158 such that the member 180 is displaced by the movement of the slide component 155. As the bi-fold door 102 is being switched from the unlocked state to the locked state, the track pin 187 is initially in the first position 200 before the foot pedal 138 is depressed by the user's foot. In the first position 200, the track pin 187 abuts a protrusion 208 that protrudes outward from a central region of the track component 182.

The track pin 187 abuts a first surface 210 of the protrusion 208 when the track pin 187 is in the first position 200. The first surface 210 may be a semi-circular surface, an arced surface, or some other type of curved surface. The track pin 187 may be held in place by the first surface 210 of the protrusion 208 such that the track pin 187 remains in the first position and the lock rod 146 remains in the unlocked state until the foot pedal 138 is depressed. After the foot pedal 138 is depressed downward, the track pin 187 moves downward by movement of the member 180 along with the slide component 155 as the track pin is in mechanical cooperation with the member 180. As the slide component 155 moves downward, the member 180 rotates in a counter-clockwise direction such that the track pin 187 moves in a leftward and downward direction along the first pathway 204.

After the foot pedal 138 has been fully depressed, the user releases the foot pedal 138 such that the foot pedal 138 moves in the upward direction opposite to the downward direction. As the foot pedal 138 moves upward, the lock rod 146, the slide component 155, the member 180, and the track pin 187 move in the upward direction due to the at least one spring 196 applying the opposing force to the slide component 155. As the at least one spring 196 moves these components upward, the track pin 187 moves along the first pathway 204 to the second position 202 such that the track pin 187 abuts a second surface 212 of the track component 182 that at least partially delimits the track 194. The second surface may be a semi-circular surface, an arced surface, or some other type of curved surface. As the track pin 187 moves upward along the first pathway 204 the member 180 rotates in a clockwise direction. When the track pin 187 is in the second position 202, the lock rod 146 is in the extended position in which the lock rod 146 passes through the opening in the horizontal portion 150 of the header 104 locking the bi-fold door 102 in the closed position. When the lock rod 146 is in the extended position and extends through the opening in the horizontal portion 150 of the header 104, the bi-fold door 102 is in the locked state in which the bi-fold door 102 may not be readily moved from the closed position to the opened position.

Once the user has completed their use of the bathroom, the user washes their hands in a sink present within the lavatory. After washing their hands, the user unlocks the bi-fold door 102 by depressing the foot pedal 138 again. When the foot pedal 138 is depressed again, the lock rod 146 moves downward along with the foot pedal 138, the slide component 155 moves downward along with the lock rod 146 compressing the at least one spring 196, and the member 180 moves downward and rotates in a counter-clockwise direction and then rotates in a clockwise direction such that the track pin 187 moves away from the second position along the second pathway 206 of the track 194. Along the second pathway 206, the track pin 187 abuts a third surface 214 that partially delimits the track 194 of the track component 182. The third surface 214 is aligned with the first surface 210. After the foot pedal 138 is fully depressed, the user releases the foot pedal 138 such that the foot pedal 138, the lock rod 146, the slide component 155, the member 180, and the track pin 187 moves upward away from the third surface 214 towards the first surface 210. As these components move upward, the track pin 187 moves into the first position 200 such that the track pin 187 abuts the first surface 210 of the protrusion 208 such that the lock rod 146 is in the retracted position and the bi-fold door 102 is in the unlocked state.

After unlocking the bi-fold door 102, the user then actuates the hands-free actuation mechanism 126 or interacts with the hands-free actuation mechanism 126. This actuation or interaction results in the automated opening mechanism 124 moving the bi-fold door 102 from the closed position to the opened position such that the user may then exit the lavatory without having to physically touch the bi-fold door 102 after washing their hands. This hands-free and non-contact opening of the bi-fold door 102 to exit the lavatory provides the user with a more sanitary and hygienic experience when going to the lavatory on the aircraft reducing germs or pathogens spread between passengers or individuals present on an aircraft.

While the above method is described as utilizing the foot pedal 138, the same or similar method may be carried out or performed by a user by instead manually actuating the hand lever 144 with their hands. Accordingly, instead of depressing the foot pedal 138 to actuate the lock rod 146 from the retracted position to the extended position and vice versa, the user depresses the hand lever 144 to actuate the lock rod 146 from the retracted position to the extended position and vice versa.

FIG. 4F is an enlarged view of the hand lever 144 when the lock rod 146 is in the extended position such that the bi-fold door 102 is locked and is not readily movable from the closed position to the opened position. FIG. 4G is an enlarged view of the hand lever 144 when the lock rod 146 is in the retracted position such that the bi-fold door is unlocked and is readily moveable from the closed position to the opened position. The hand lever 144 is in mechanical cooperation with the lock rod 146. The hand lever 144 may be mechanically coupled to the lock rod 146.

As shown in FIG. 4F, the hand lever 144 includes the “locked” indicator 216 that is exposed indicating that the lock rod 146 is in the extended position such that the bi-fold door 102 is locked. The “locked” indicator 216 may be a symbol, a label, or some other indicator that is readily visible by a user present within the lavatory such that the user is informed of the state (e.g., locked or unlocked) of the bi-fold door 102. The “locked” indicator 216 may be color coded such that the user may readily determine that the bi-fold door 102 is locked. When actuating the lock rod 146 utilizing the foot pedal 138, the hand lever 144 may move along with the lock rod 146 such that the hand lever 144 indicates to the user within the lavatory that the bi-fold door 102 has been switched from being unlocked to locked. The “locked” indicator 216 may be a locked padlock.

As shown in FIG. 4G, the hand lever 144 includes an “unlocked” indicator 218 that is exposed indicating that the lock rod 146 is in the retracted position such that the bi-fold door 102 is unlocked. The “unlocked” indicator 218 may be a symbol, a label, or some other indicator that is readily visible by a user present within the lavatory such that the user is informed of the state (e.g., locked or unlocked) of the bi-fold door 102. The “unlocked” indicator 218 may be color coded such that the user may readily determine that the bi-fold door 102 is unlocked. When actuating the lock rod 146 utilizing the foot pedal 138, the hand lever 144 may move along with the lock rod 146 such that the hand lever 144 indicates to the user within the lavatory that the bi-fold door 102 has been switched from being locked to unlocked. The “unlocked” indicator 218 may be an unlocked padlock.

As shown in FIGS. 4F and 4G, an actuation direction indicator 220 is present along the center post 102c. The actuation direction indicator 220 is an arrow that points downward such that the user is informed of the direction the hand lever is to be depressed to actuate the hand lever 144 to actuate the lock rod 146 for locking and unlocking the bi-fold door 102. As discussed earlier, the hand lever 144 may function in the same or similar fashion as the foot pedal 138 as described with respect to FIG. 4E. However, instead of the user depressing the foot pedal 138 with their foot, the user depresses the hand lever 144 downward with their hand.

FIG. 5A illustrates a top plan view of the bi-fold door 102 when the bi-fold door 102 is in the opened position. When the bi-fold door 102 is in the opened position, the bi-fold door 102 is folded up such that the first external surface 106 faces away from the second external surface 108, and the first internal surface 110 faces towards the second internal surface 112. The first and second external surfaces 106, 108, respectively, are further away from each other as compared to the first and second internal surfaces 110, 112, respectively, when the bi-fold door 102 is in the opened position. When the bi-fold door 102 is in the opened position, a user may readily enter (e.g., ingress) or exit (e.g., egress) the lavatory as access to the lavatory is not limited or denied by the bi-fold door 102 when in the opened position.

FIG. 5B is an enlarged, partial view of the upper left-hand corner of the bi-fold door system 100 when the bi-fold door 102 is in the opened position as shown in FIG. 5A. In FIG. 5B, a portion of the header 104 has been cut away such that components within or along the header 104 are readily visible.

As shown in FIG. 5B, the catch 160 includes a first opening 222 and a second opening 224. The first opening 222 is closer to the first end 164 of the catch 160 than the second end 166 of the catch 160. The second opening 224 is closer to the second end 166 of the catch 160 than the first end 164 of the catch 160. A first catch guide pin 228, which may be mechanically coupled to the header 104, extends into the first opening 222 such that the first opening 222 receives the first catch guide pin 228. A second catch guide pin 230, which may be mechanically coupled to the header 104, extends into the second opening 224 such that the second opening 224 receives the first catch guide pin. The first and second catch guide pins 228, 230, respectively, mechanically cooperate with the catch 160. The surface 232 of the catch 160 is adjacent to the track 152. The surface 232 of the catch 160 may be partially within the track 152 and may partially delimit the track 152.

As readily shown in FIG. 5B, the track follower 154 is on the left-hand side of the first end 164 of the catch 160 when bi-fold door 102 is in the fully opened position. The catch 160 mechanically cooperates with the track follower 154, which is mechanically coupled to the second panel 102b, and mechanically cooperates with the dampener 162 within or along the header 104. The catch 160 and the dampener 162 mechanically cooperate together along with the track follower 154 to delay the bi-fold door 102 from moving away from the opened position towards the closed position due to the torque applied to the bi-fold door 102 by the torsional spring 168. In other words, the catch 160 along with the dampener 162 hold the track follower 154 at the first end 111 of the header 104 for a selected period of time.

As the bi-fold door 102 moves from the closed position to the opened position due to the user actuating or interacting with the hands-free actuation mechanism 126 such that the automated opening mechanism 124 actuates the bi-fold door 102 from the closed position to the opened position, the track follower 154 moves away from the second end 113 of the header 104 towards the first end 111 of the header 104. In other words, the track follower 154 moves from right to left based on the orientation as shown in FIG. 5B.

As the track follower 154 comes closer to the first end 111, the track follower comes into contact with the surface 232 of the catch 160. As the track follower 154 continues to move towards the first end 111 of the header 104, the track follower 154 pushes upward on the surface 232 such that the catch 160 moves upward in a clockwise motion about the second catch guide pin 230 based on angle the surface 232 is at relative to the header 104. In other words, the catch 160 moves upward based on the orientation as shown in FIG. 5B. The catch 160 moves upward based on the mechanical cooperation between the first and second openings 222, 224, respectively, within the first and second catch guide pins 228, 230, respectively. For example, the catch 160 moves upward as surfaces of the catch 160 delimiting the first and second openings 222, 224 move about the first and second catch guide pins 228, 230, respectively, such that the catch 160 moves upward as the track follower 154 slides along the surface 232 of the catch 160. When the catch moves upward, the first end 164 may move substantially upward whereas the second end 166 may move slightly downward as the catch 160 may rotate in a clockwise direction about the second catch guide pin 230.

As the catch 160 moves upward and to the right, the track follower 154 continues to slide along the surface 232 until the track follower moves past the first end 164 of the catch 160. Once the track follower 154 moves past the first end 164 of the catch 160, the catch 160 moves downward and the track follower 154 abuts the first end 164 of the catch 160. For example, the catch 160 moves downward as the surfaces of the catch 160 delimiting the first and second openings 222, 224 move about the first and second catch guide pins 228, 230, respectively, such that the catch 160 moves downward as the track follower 154 slides along the surface 232 of the catch 160. When the catch moves downward, the first end 164 may move substantially downward whereas the second end 166 may remain substantially stationary as the catch 160 may rotate in a counter-clockwise direction about the second catch guide pin 230.

Once the track follower 154 has been moved past the first end 164 of the catch 160, operation of the automated opening mechanism 124 is seized such that the track follower 154 abuts the first end of the catch 160. After seizing operation of the automated opening mechanism 124, the torsional spring 168 continues to apply the torque to the bi-fold door 102 biased towards the closed position. The torque applied by the torsional spring 168 to the bi-fold door 102 results in the track follower 154 pushing against the first end 164 of the catch 160 as the torsional spring 168 applies the torque to the bi-fold door 102 biased towards the closed position. In other words, the torsional spring 168 mechanically cooperates with the bi-fold door 102 such that the track follower 154 reacts by pushing against the first end 164 of the catch 160 in a rightward direction based on the orientation as shown in FIG. 5B. As the track follower 154 pushes against the first end 164 of the catch 160, the second end 166 of the catch 160 moves to the right and pushes against the dampener 162, and the first end 164 of the catch 160 moves upward and to the right by rotating clockwise about the second guide pin 230. The second end 166 of the catch 160 pushing against the dampener results in compressing and depressing the dampener 162 in a rightward direction based on the orientation as shown in FIG. 5B. After the dampener 162 is compressed by a selected amount after a selected period of time, the first end 164 moves upward enough such that the track follower 154 moves past the first end 164 of the catch 160 and begins moving along the track 152 of the header 104 towards the second end 113 of the header 104. The track 154 moves along the track 154 past the second end 166 of the catch 160 towards the second end 113 of the header 104.

In view of the above discussion, the catch 160 mechanically cooperates with the track follower 154 and the dampener 162 to hold the bi-fold door in the opened position for a selected period of time. In other words, the catch 160 and the dampener 162 mechanically cooperate to hold the track follower 154 at the first end 111 of the header 104 delaying the track follower 154 from moving away from the first end 111 of the header 104 towards the second end 113 of the header 104. This delay in the bi-fold door 102 moving away from the opened position provides a user exiting the lavatory after going to the bathroom (e.g., defecating, urinating, and/or washing their hands) to exit the lavatory without physically contacting the bi-fold door 102.

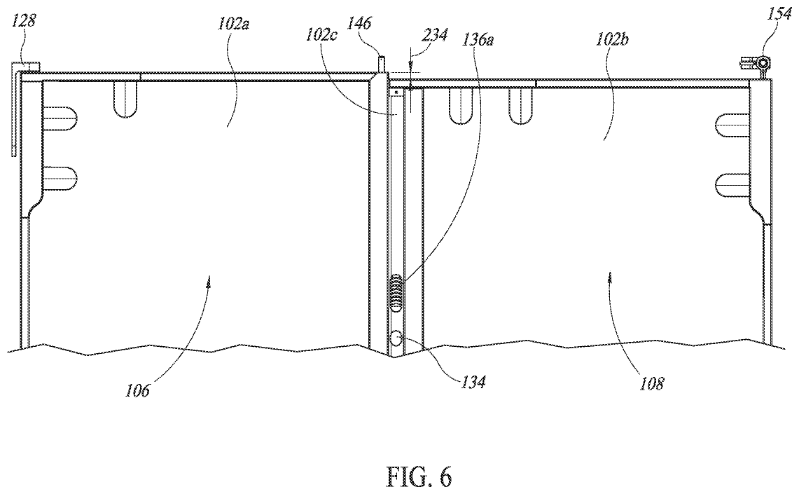

FIG. 6 is an enlarged, partial view of the top end of the embodiment of the bi-fold door 102. FIG. 6 is directed to the bi-fold door 102 when the first panel 102a and the second panel 102b are offset relative to each other due to an external disturbance (e.g., turbulence, vibration, etc.) that the bi-fold door 102 is exposed while an aircraft is underway (e.g., flying). For example, respective top ends of the first panel 102a and the second panel 102b are offset relative to each other by a dimension 234 as shown in FIG. 6. In this situation, the respective top end of the first panel 102a is higher relative to the respective top end of the second panel 102b. However, in other situations, the respective top end of the second panel 102b may be higher than the respective top end of the first panel 102a, or the respective top ends of the first panel 102a and the second panel 102b may be substantially aligned with each other (e.g., flush or coplanar relative to each other such that the respective top ends of the first and second panels 102a, 102b, respectively, are substantially collinear with each other).

As discussed earlier, the first and second spherical hinges 128, 130, respectively, and the first and second ball bearings 177, 198, respectively, provide the first panel 102a, the second panel 102b, and the center post 102c degrees of freedom relative to each other such that the bi-fold door 102 is deflection and racking tolerant. In other words, the first and second spherical hinges 128, 130, respectively, in combination with the first and second ball bearings 177, 198, respectively, accommodate aircraft deflections such that the likelihood of the bi-fold door 102 binding up preventing operation of the bi-fold door 102 is reduced.

A device may be summarized as including a header and a bi-fold door in mechanical cooperation with the header, the bi-fold door including: an opened position and a closed position; an exterior surface and an interior surface, the exterior surface is opposite to the interior surface; a top end and a bottom end, the top end is opposite to the bottom end; a first panel extends from the top end to the bottom end; a second panel in mechanical cooperation with the first panel, the second panel extends from the top end to the bottom end; a center post between the first panel and the second panel, the center post mechanically couples the first panel to the second panel; a lock rod including an extended position and a retracted position, the lock rod configured to lock the bi-fold door in the closed position when in the extended position; and a lock pedal in mechanical cooperation with the lock rod and accessible at the interior surface of the first panel, the lock pedal is closer to the bottom end than the top end and is configured to actuate the lock rod to unlock and lock the bi-fold door.

The device may further include an opening mechanism at the top end of the bi-fold door.

The device may further include an electrical actuator in mechanical cooperation with the opening mechanism, the electrical actuator configured to actuate the opening mechanism to move the bi-fold door from the closed position to the opened position.

The device may further include an actuation pedal in mechanical cooperation with the opening mechanism, the actuation pedal configured to actuate the opening mechanism to move the bi-fold door from the closed position to the opened position.

The lock pedal and the actuation pedal may be foot pedals configured to provide hand-free operation of the bi-fold door by a foot of a user.

The bi-fold door may further include an ambidextrous handle extending outward from the exterior surface of the bi-fold door.

The bi-fold door may further include a first spherical hinge at the top end of the first panel; a second spherical hinge at the bottom end of the first panel; a first ball bearing at the top end of bi-fold door and in the center post; a second ball bearing at the bottom end of bi-fold door and in the center post; a torsional spring is in the center post, is in mechanical cooperation with the first and second panels, and is biased to move the first panel and the second panel away from the opened position towards the closed position; and a rotary dampener in mechanical cooperation at the center post, the rotary dampener is in mechanical cooperation with the torsional spring.

The first and second ball bearings may be free to translate vertically and rotational.

The device may further include an escapement mechanism in mechanical cooperation with the lock pedal and the lock rod, the escapement mechanism including: a track pin in mechanical cooperation with the lock pedal and the lock rod; and a track in mechanical cooperation with the track pin, the track including: a first pathway along which the track pin moves from a first position to a second position, wherein, when the track pin is in the second position, the lock rod is in the extended position; and a second pathway along which the track pin moves from the second position to the first position, wherein, when the track pin is in the first position, the lock rod is in the retracted position.

The header may further include a track; and the bi-fold door may further include a track follower within the track of the header, the track follower configured to move along the track in a first direction and a second direction opposite to the first direction.

The device may further include a spring loaded dampener in the header; a first guide pin in the header; a second guide pin in the header; and a catch in mechanical cooperation with the first guide pin and the second guide pin, the catch including: a first opening in which the first guide pin is received; a second opening in which the second guide pin is received; and a first end that abuts the spring loaded dampener.

The track follower may abut a second end of the catch when the bi-fold door is in the closed position, the second end of the catch is opposite to the first end of the catch, the track follower configured to push against the second end of the catch to push the first end of the catch against the spring loaded dampener to compress the spring loaded dampener.

A device may be summarized as including a header including a track having a first end and a second end opposite to the first end; a first guide pin in the header; a second guide pin in the header; a catch in mechanical cooperation with the first and second guide pins, the catch including a third end and a fourth end opposite to the first end; a spring loaded dampener abuts the third end of the catch; and a bi-fold door in mechanical cooperation with the header, the bi-fold door including: an opened position and closed position; a torsional spring biased towards the closed position; and a track follower in mechanical cooperation with the track, and, when the bi-fold door is in the opened position, the track follower abuts the fourth end of the catch and is closer to the first end than the second end of the header, wherein the torsional spring is configured to apply a torque to the bi-fold door biased towards the closed position such that the track follower pushes against the fourth end of the catch pushing the third end of the catch against the spring loaded dampener compressing the spring loaded dampener.

When the spring loaded dampener is compressed by a selected distance, the track follower may move past the fourth end and third end of the catch along the track from the opened position towards the closed position by the torque applied to the bi-fold door by the torsional spring.

The device may further include a lock rod including an extended position and a retracted position, the lock rod locks the bi-fold door in the closed position when in the extended position; a lock pedal in mechanical cooperation with the lock rod, the lock pedal configured to move the lock rod from the extended position to the retracted position and move the lock rod from the retracted position to the extended position; and an escapement mechanism in mechanical cooperation with the lock rod and the lock pedal, the escapement mechanism including: an escapement track pin in mechanical cooperation with the lock pedal and the lock rod; and an escapement track in mechanical cooperation with the escapement track pin, the escapement track including: a first pathway along which the escapement track pin moves from a first position to a second position, wherein, when the track pin is in the second position, the lock rod is in the extended position; and a second pathway along which the track pin moves from the second position to the first position, wherein, when the track pin is in the first position, the lock rod is in the retracted position.

The device may further include a rotary dampener in mechanical cooperation with the torsional spring.

A method may be summarized as including actuating a lock pedal to unlock a lock rod of a bi-fold door; actuating an actuation pedal to move the bi-fold door from a closed position to an opened position including: translating a track follower mechanically coupled to the bi-fold door along a track of a header past a catch in the header; holding the bi-fold door in an opened position for a selected period of time by abutting the track follower against the catch and compressing a spring loaded dampener abutting the catch for the selected period of time; and releasing the bi-fold door from the opened position after the selected period of time by compressing the spring loaded dampener by a selected distance.

Compressing the spring loaded dampener may further include applying a torque to the bi-fold door through a torsional spring biased towards the closed position of the bi-fold door pushing the track follower against the catch compressing the spring loaded dampener.

The method may further include translating the track follower along the track moving the bi-fold door from the opened position towards the closed position by the torque applied to the bi-fold door by the torsional spring.

Translating the track follower along the track by the torque applied to the bi-fold door by the torsional spring may entirely move the bi-fold door from the opened position to the closed position.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A device, comprising:
a header; and
a bi-fold door in mechanical cooperation with the header, the bi-fold door including:
an opened position and a closed position;
an exterior surface and an interior surface, the exterior surface is opposite to the interior surface;
a top end and a bottom end, the top end is opposite to the bottom end;
a first panel extends from the top end to the bottom end;
a second panel in mechanical cooperation with the first panel, the second panel extends from the top end to the bottom end;
a center post between the first panel and the second panel, the center post mechanically couples the first panel to the second panel;
a lock rod including an extended position and a retracted position, the lock rod configured to lock the bi-fold door in the closed position when in the extended position; and
a lock pedal in mechanical cooperation with the lock rod and accessible at the interior surface of the first panel, the lock pedal is closer to the bottom end than the top end and is configured to actuate the lock rod to unlock and lock the bi-fold door.

2. The device of claim 1, further comprising an opening mechanism at the top end of the bi-fold door.

3. The device of claim 2, further comprising an electrical actuator in mechanical cooperation with the opening mechanism, the electrical actuator configured to actuate the opening mechanism to move the bi-fold door from the closed position to the opened position.

4. The device of claim 2, further comprising an actuation pedal in mechanical cooperation with the opening mechanism, the actuation pedal configured to actuate the opening mechanism to move the bi-fold door from the closed position to the opened position.

5. The device of claim 4, wherein the lock pedal and the actuation pedal are foot pedals configured to provide hand-free operation of the bi-fold door by a foot of a user.

6. The device of claim 1, wherein the bi-fold door further includes an ambidextrous handle extending outward from the exterior surface of the bi-fold door.

7. The device of claim 1, wherein the bi-fold door further includes:
a first spherical hinge at the top end of the first panel;
a second spherical hinge at the bottom end of the first panel;
a first ball bearing at the top end of bi-fold door and in the center post;
a second ball bearing at the bottom end of bi-fold door and in the center post;
a torsional spring is in the center post, is in mechanical cooperation with the first and second panels, and is biased to move the first panel and the second panel away from the opened position towards the closed position; and
a rotary dampener in mechanical cooperation at the center post, the rotary dampener is in mechanical cooperation with the torsional spring.

8. The device of claim 7, wherein the first and second ball bearings are free to translate vertically and rotational.

9. The device of claim 1, further comprising:
an escapement mechanism in mechanical cooperation with the lock pedal and the lock rod, the escapement mechanism including:
a track pin in mechanical cooperation with the lock pedal and the lock rod; and
a track in mechanical cooperation with the track pin, the track including:
a first pathway along which the track pin moves from a first position to a second position, wherein, when the track pin is in the second position, the lock rod is in the extended position; and
a second pathway along which the track pin moves from the second position to the first position, wherein, when the track pin is in the first position, the lock rod is in the retracted position.

10. The device of claim 1, wherein:
the header further includes a track; and
the bi-fold door further includes a track follower within the track of the header, the track follower configured to move along the track in a first direction and a second direction opposite to the first direction.

11. The device of claim 10, further comprising:
a spring loaded dampener in the header;
a first guide pin in the header;
a second guide pin in the header; and
a catch in mechanical cooperation with the first guide pin and the second guide pin, the catch including:
a first opening in which the first guide pin is received;
a second opening in which the second guide pin is received; and
a first end that abuts the spring loaded dampener.

12. The device of claim 11, wherein the track follower abuts a second end of the catch when the bi-fold door is in the closed position, the second end of the catch is opposite to the first end of the catch, the track follower configured to push against the second end of the catch to push the first end of the catch against the spring loaded dampener to compress the spring loaded dampener.

13. A device, comprising:
a header including a track having a first end and a second end opposite to the first end;
a first guide pin in the header;
a second guide pin in the header;
a catch in mechanical cooperation with the first and second guide pins, the catch including a third end and a fourth end opposite to the first end;
a spring loaded dampener abuts the third end of the catch; and
a bi-fold door in mechanical cooperation with the header, the bi-fold door including:
an opened position and closed position;
a torsional spring biased towards the closed position; and
a track follower in mechanical cooperation with the track, and, when the bi-fold door is in the opened position, the track follower abuts the fourth end of the catch and is closer to the first end than the second end of the header,
wherein the torsional spring is configured to apply a torque to the bi-fold door biased towards the closed position such that the track follower pushes against the fourth end of the catch pushing the third end of the catch against the spring loaded dampener compressing the spring loaded dampener.

14. The device of claim 13, wherein, when the spring loaded dampener is compressed by a selected distance, the track follower moves past the fourth end and third end of the catch along the track from the opened position towards the closed position by the torque applied to the bi-fold door by the torsional spring.

15. The device of claim 13, further comprising:
a lock rod including an extended position and a retracted position, the lock rod locks the bi-fold door in the closed position when in the extended position;
a lock pedal in mechanical cooperation with the lock rod, the lock pedal configured to move the lock rod from the extended position to the retracted position and move the lock rod from the retracted position to the extended position; and
an escapement mechanism in mechanical cooperation with the lock rod and the lock pedal, the escapement mechanism including:
an escapement track pin in mechanical cooperation with the lock pedal and the lock rod; and
an escapement track in mechanical cooperation with the escapement track pin, the escapement track including:
a first pathway along which the escapement track pin moves from a first position to a second position, wherein, when the track pin is in the second position, the lock rod is in the extended position; and
a second pathway along which the track pin moves from the second position to the first position, wherein, when the track pin is in the first position, the lock rod is in the retracted position.

16. The device of claim 13, further comprising a rotary dampener in mechanical cooperation with the torsional spring.

17. A method, comprising:
actuating a lock pedal to unlock a lock rod of a bi-fold door;
actuating an actuation pedal to move the bi-fold door from a closed position to an opened position including:
translating a track follower mechanically coupled to the bi-fold door along a track of a header past a catch in the header;
holding the bi-fold door in an opened position for a selected period of time by abutting the track follower against the catch and compressing a spring loaded dampener abutting the catch for the selected period of time; and
releasing the bi-fold door from the opened position after the selected period of time by compressing the spring loaded dampener by a selected distance.

18. The method of claim 17, wherein compressing the spring loaded dampener further includes applying a torque to the bi-fold door through a torsional spring biased towards the closed position of the bi-fold door pushing the track follower against the catch compressing the spring loaded dampener.

19. The method of claim 18, further comprising translating the track follower along the track moving the bi-fold door from the opened position towards the closed position by the torque applied to the bi-fold door by the torsional spring.

20. The method of claim 19, wherein translating the track follower along the track by the torque applied to the bi-fold door by the torsional spring entirely moves the bi-fold door from the opened position to the closed position.
